(19) United States
(12) Patent Application Publication
(10) Pub. No.: US 2026/0289431 A1
(43) Pub. Date: Sep. 24, 2026

(54) SYSTEM

(71) Applicant: SoftBank Group Corp., Tokyo (JP)

(72) Inventor: Atsushi SASAKI, Tokyo (JP)

(73) Assignee: SoftBank Group Corp., Tokyo (JP)

(21) Appl. No.: 19/561,892

(22) Filed: Mar. 10, 2026

(30) Foreign Application Priority Data
Mar. 19, 2025 (JP) 2025-044495

(51) Int. Cl. G06Q 10/02

(52) U.S. Cl. CPC G06Q 10/02

(57) ABSTRACT

A system includes a processor that is configured to provide an interface for inputting a user's budget, schedule, and detailed preferences, analyze information input through the interface and generate a prompt for instructing a specific processing operation to a generative AI model, use the generative AI model to receive the prompt as input and generate a proposal that matches the user's preferences, and visually format content of the generated proposal for display and display the visually formatted proposal content on a user interface.

### CROSS-REFERENCE TO RELATED APPLICATION

This application is based on and claims priority under 35 USC 119 from Japanese Patent Application No. 2025-044495 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional travel planning systems and online reservation services mainly provide static search and filter functions based on predetermined conditions such as destination, date, and price range. In such systems, a user is required to manually combine multiple pieces of information, repeatedly adjust search conditions, and individually select transportation, accommodation, and activities. As a result, it is difficult to efficiently obtain a travel plan that is closely tailored to the user's detailed preferences, such as personal budget balance, schedule constraints, and qualitative preferences for experiences.

Furthermore, conventional systems do not fully utilize generative AI models to interpret ambiguous or complex user requirements and convert them into concrete, optimized travel proposals. Even if AI technologies are used for recommendation, they typically rely on fixed rule-based logic or simple similarity searches and cannot flexibly generate proposals that comprehensively reflect a user's input, past travel data, and regional tourism information.

In addition, conventional systems often handle travel reservations and regional information in a fragmented manner, requiring the user to access multiple services to collect information on sightseeing spots, events, and local experiences. Therefore, it is difficult to provide a comprehensive travel experience that substitutes for travel agency operations and contributes to revitalization of travel, regions, and the economy.

Therefore, there is a need for a system that, based on a user's budget, schedule, and detailed preferences, automatically generates an optimal and customized travel proposal by using a generative AI model, and that presents the generated proposal in an intuitive and visually formatted manner. In particular, there is a demand for a system that learns past travel data, selects an optimal plan matching the user's input, and further associates the generated travel plan with regional tourism information and event information to provide a comprehensive travel experience.

### SUMMARY

In order to solve the above-described problems, an aspect of the present invention provides a system comprising a processor, wherein the processor is configured to provide an interface for inputting a user's budget, schedule, and detailed preferences. The processor analyzes information input through the interface and generates a prompt for instructing a specific processing operation to a generative AI model. The processor then uses the generative AI model to receive the prompt as input and generate a proposal that matches the user's preferences. The processor further visually formats content of the generated proposal for display and displays the visually formatted proposal content on a user interface, thereby allowing the user to intuitively understand the generated travel plan.

In one embodiment, the processor is configured to learn past travel data, including historical travel itineraries, user attributes, and evaluation information, and compare the learned past travel data with input information from the user. Based on a result of the comparison, the processor selects an optimal travel plan and proposes the optimal travel plan to the user. By combining learning of past travel data with analysis of current user input, the processor can generate a travel proposal that is optimized in terms of budget, schedule, and satisfaction for the individual user.

In another embodiment, the processor is configured to associate a generated travel plan with regional tourism information and event information, including sightseeing spots, local events, seasonal festivals, and regional experience programs. The processor then provides a comprehensive travel experience to the user in a manner substituting for travel agency operations and contributing to revitalization of travel, revitalization of regions, and revitalization of an economy. Through this configuration, the system not only automates travel planning but also integrates regional information into the generated proposals, thereby enabling provision of high value-added travel experiences.

The term “processor” refers to a hardware or software processing unit, or a combination thereof, that executes instructions to perform the functions described in the present specification and claims, including analysis of user input, generation of prompts, interaction with a generative AI model, learning from past data, and generation and formatting of proposals.

The term “interface” refers to a user-facing input and/or output mechanism, implemented for example as a graphical user interface on a terminal device, through which a user inputs information such as budget, schedule, and detailed preferences, and through which proposals or travel plans are presented to the user.

The term “user's budget” refers to monetary constraints or target cost ranges specified by the user for a travel plan, including, for example, total travel budget or partial budgets such as budgets for transportation and accommodation.

The term “schedule” refers to temporal conditions specified by the user in relation to travel, including at least one of departure dates, return dates, check-in and check-out dates, duration of stay, and time-related constraints.

The term “detailed preferences” refers to qualitative or quantitative conditions specified by the user in addition to budget and schedule, including preferences for destinations, transportation modes, accommodation types, activities, comfort level, proximity to facilities, and any free-form requirements described in natural language.

The term “analyze” refers to performing one or more processing operations on input information, such as parsing, extracting parameters, normalizing, classifying, interpreting ambiguous expressions, and converting such information into data structures suitable for subsequent processing.

The term “prompt” refers to a data structure or text sequence generated based on analyzed user input, which is provided as input to a generative AI model to instruct the generative AI model to perform a specific processing operation, such as generating a travel proposal.

The term “specific processing operation” refers to a defined computational task to be performed by a generative AI model, including, for example, generating a travel plan, proposing itineraries, summarizing options, adapting recommendations to user constraints, or combining regional information with travel elements.

The term “generative AI model” refers to an artificial intelligence model that, upon receiving an input such as a prompt, generates new content, including text, structured data, or other representations, based on learned patterns from training data, and is capable of generating travel proposals in response to user requirements.

The term “proposal that matches the user's preferences” refers to a generated travel plan or recommendation that satisfies, to at least a predetermined degree, the user's budget, schedule, and detailed preferences as interpreted and processed by the system.

The term “visually format” refers to converting generated proposal content into a presentation-ready form suitable for display, including arranging items, adding layout structure, highlighting key information, grouping related information, and applying styles so that the proposal is easy for the user to understand.

The term “user interface” refers to a display environment, such as a screen on a terminal device, through which the user can view information, including generated proposals, and optionally interact with the system, for example by selecting options or revising input.

The term “past travel data” refers to data related to previous travel instances, including at least one of past itineraries, user profiles, destinations, budgets, ratings, feedback, booking histories, and contextual information associated with historical travel.

The term “learn” refers to processing past travel data by using machine learning, statistical analysis, pattern extraction, or similar techniques, so that the processor can derive models or rules enabling improved selection or generation of travel plans.

The term “compare” refers to evaluating relationships between the user's current input information and learned representations or patterns derived from past travel data, including similarity assessment, matching, or scoring, in order to identify suitable travel plans.

The term “optimal travel plan” refers to a travel plan selected or generated so as to maximize or sufficiently improve one or more evaluation criteria, such as adherence to budget, schedule feasibility, predicted user satisfaction, or relevance to user preferences.

The term “regional tourism information” refers to information related to tourism resources in a region, including sightseeing spots, landmarks, recommended routes, dining establishments, local attractions, and services available to travelers in that region.

The term “event information” refers to information about time-specific or location-specific events, including festivals, cultural events, concerts, exhibitions, seasonal activities, and other organized experiences available within a region and during particular periods.

The term “generated travel plan” refers to an itinerary or structured proposal output by the system, including at least one of transportation options, accommodation options, schedules, and suggested activities, based on processing by the generative AI model and other components.

The term “associate” refers to linking or combining a generated travel plan with regional tourism information and event information so that the travel plan includes, references, or is enriched by such information in a coordinated manner.

The term “comprehensive travel experience” refers to a user experience in which transportation, accommodation, sightseeing, events, and other activities are presented in an integrated manner, enabling the user to understand and enjoy an end-to-end travel plan without needing to manually combine fragmented information.

The term “travel agency operations” refers to functions conventionally performed by travel agencies, including planning itineraries, selecting suitable transportation and accommodation, recommending sightseeing spots and activities, and providing coordinated travel proposals to customers.

The term “revitalization of travel” refers to increasing the frequency, diversity, or quality of travel activities by users through more attractive, accessible, or personalized travel proposals.

The term “revitalization of regions” refers to promoting economic and cultural activity in specific geographic areas by encouraging travel to those areas, increasing exposure of local tourism resources, and directing users to local businesses and events.

The term “revitalization of an economy” refers to contributing to broader economic growth by stimulating spending in travel-related industries, such as transportation, accommodation, dining, and tourism services, as a result of increased and enhanced travel activity enabled by the system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

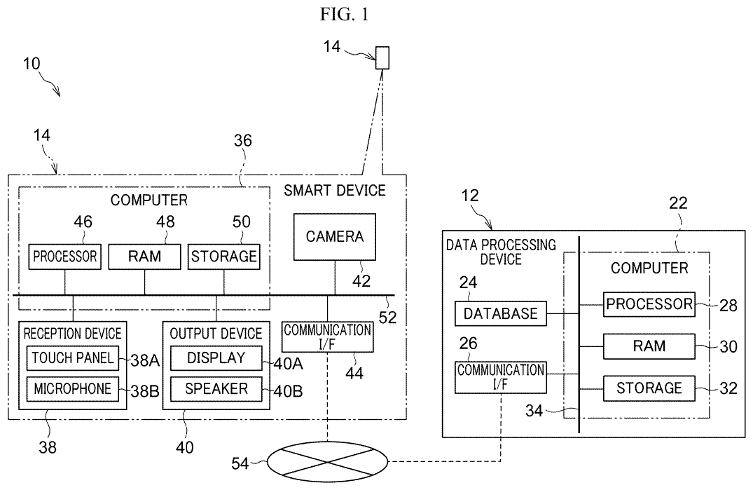

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

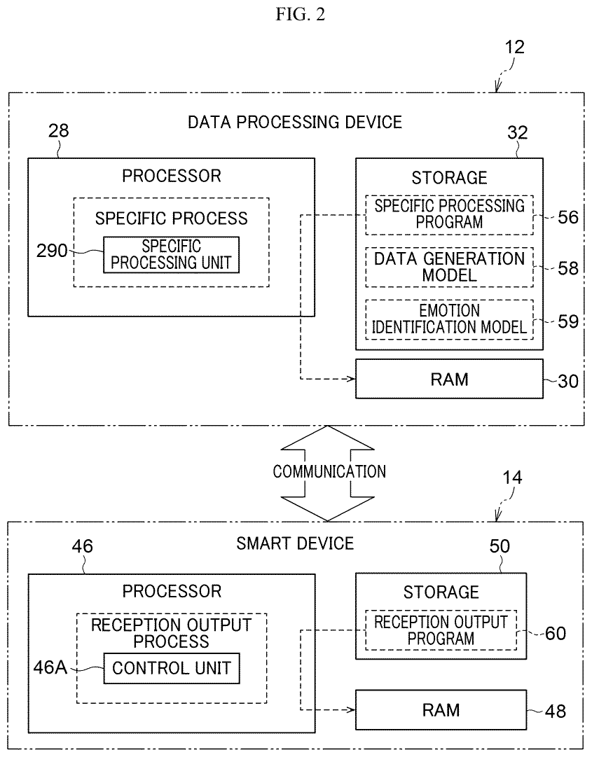

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented travel planning systems generally collect user inputs such as budget, dates, and preferences, and then apply rule-based search or static recommendation logic to retrieve itineraries from fixed databases. Such systems suffer from several technical limitations in terms of data handling and human-machine interaction. For example, these systems typically rely on rigid input formats and predetermined query patterns, which make it difficult to translate diverse, natural user requirements into a machine-processable representation for generating tailored proposals. As a result, system resources are often used inefficiently: multiple ad hoc queries are issued, intermediate data structures are repeatedly constructed and discarded, and network communication overhead increases due to iterative trial-and-error searches.

In addition, when large-scale data-driven models, such as generative language models, are introduced into the processing pipeline, conventional systems do not provide a structured mechanism for converting normalized user conditions into prompt sentences suitable for such models, nor do they provide a feedback loop that systematically incorporates user evaluations to refine subsequent model inputs. In typical integrations, user conditions are directly concatenated into free-form text without intermediate validation or normalization, which can result in ambiguous prompts, unstable model behavior, and increased computational overhead on the model side due to poorly constrained requests.

Furthermore, conventional systems generally treat the output of a generative model as unstructured text and simply display it to the user, without performing machine-level parsing or hierarchical structuring of the generated content. This lack of structured post-processing prevents efficient reuse of the generated data, makes it difficult to perform automated comparisons between multiple itineraries, and forces the user interface to rely on simplistic text rendering. As a result, the human-machine interface becomes less efficient, requiring users to manually extract and compare details, which increases cognitive load and interaction time.

There is therefore a need for an improved computer-based system that (i) systematically transforms user conditions into validated, normalized, and aggregated internal condition information, (ii) generates machine-optimized prompt sentences for a generative AI model in a repeatable and structured way, (iii) parses and converts the generated itinerary information into hierarchical structured data suitable for efficient display and further computation, and (iv) closes the loop by capturing user evaluations or revised conditions and feeding them back into the internal condition information and prompt generation mechanism. Such improvements can reduce redundant processing, stabilize interactions with the generative AI model, and enhance the efficiency and usability of the travel planning workflow executed by a processor and associated communication interfaces.

The specific processing by the specific processing unit 290 of the data processing device 12 in Example 1 is realized by the following means.

The present invention provides a server comprising a processor and a communication interface, the processor being configured to present, to a communication terminal, an operation screen for acquiring a cost condition, a time condition, and a preference condition from a user; to receive, from the communication terminal via the communication interface, structured information including the cost condition, the time condition, and the preference condition, and to perform format checking, value checking, and normalization processing on the structured information to generate normalized internal condition information; to generate, based on the internal condition information, a prompt sentence suitable for input to a generative AI model by executing template-based document generation processing or character-string concatenation processing, and to transmit, via the communication interface, request information including the prompt sentence to a generative information processing apparatus implementing the generative AI model; to receive itinerary information generated by the generative information processing apparatus in response to the prompt sentence, to analyze the itinerary information and convert the itinerary information into hierarchical structure data including day-by-day itinerary information, stay-place information, transportation information, and cost information, and to perform data formatting processing for converting the hierarchical structure data into display information visually recognizable by the user; and to transmit the display information to the communication terminal and, further, to receive, from the communication terminal, evaluation information or revised conditions relating to the itinerary information, and to update the internal condition information and the prompt sentence based on the evaluation information or the revised conditions and iteratively request regeneration of itinerary information from the generative information processing apparatus by using an updated prompt sentence. This enables improved computer functionality for travel-plan generation by structuring user inputs into validated and normalized internal condition information, by generating machine-optimized prompt sentences for a generative AI model, by converting model outputs into hierarchical structured data suitable for efficient rendering and comparison on a user interface, and by providing an iterative feedback loop that refines subsequent processing based on user evaluations, thereby reducing redundant computation, stabilizing model interactions, and enhancing the efficiency and usability of the overall computer-implemented travel planning process.

The term “processor” refers to a hardware-implemented arithmetic and logic processing unit, or a combination of such units, configured to execute instructions to perform data processing, control, and communication operations in the system.

The term “communication terminal” refers to an electronic device having a display unit and a communication function, such as a client device, configured to exchange information with the server and to present an operation screen to a user.

The term “operation screen” refers to a graphical user interface or other input interface presented on the communication terminal, through which the user can input conditions, view results, and perform operations related to itinerary generation.

The term “cost condition” refers to information representing at least one constraint or preference relating to financial aspects of an itinerary, including but not limited to a budget amount, upper or lower cost limits, or cost distribution preferences.

The term “time condition” refers to information representing temporal constraints or preferences of the user, including but not limited to desired travel dates, duration of travel, or time periods within which activities are to be scheduled.

The term “preference condition” refers to information representing qualitative or quantitative user preferences for a travel plan, including but not limited to destination types, activity types, accommodation characteristics, transportation types, or environmental preferences.

The term “structured information” refers to user condition information organized in a defined data format, such as key-value pairs, records, or objects, suitable for programmatic processing by the processor.

The term “format checking” refers to processing in which the processor verifies that structured information conforms to predetermined syntactic or data-type rules, such as checking that numeric fields, date fields, and text fields comply with expected formats.

The term “value checking” refers to processing in which the processor verifies that values included in the structured information fall within predetermined allowed ranges or satisfy predetermined logical constraints.

The term “normalization processing” refers to processing in which the processor converts user-provided data into standardized internal representations, such as converting natural language date expressions into explicit dates or converting currency-related values into a standard unit.

The term “internal condition information” refers to normalized and aggregated condition data generated from the structured information, which is stored and used by the processor as an internal representation of the user's requirements.

The term “prompt sentence” refers to a machine-generated natural-language instruction string that encodes the internal condition information and is formatted for input to a generative AI model.

The term “template-based document generation processing” refers to processing in which the processor inserts condition values into predefined text templates to form a coherent prompt sentence.

The term “character-string concatenation processing” refers to processing in which the processor constructs the prompt sentence by programmatically concatenating text fragments and condition values without necessarily using a template engine.

The term “generative AI model” refers to a data-driven information processing model, such as a neural-network-based language model, configured to generate text or other content in response to an input prompt sentence.

The term “generative information processing apparatus” refers to an information processing system that implements the generative AI model, including associated hardware and software for performing inference processing based on a prompt sentence.

The term “request information” refers to data transmitted from the processor to the generative information processing apparatus, including at least the prompt sentence and optionally additional parameters for controlling the generative AI model.

The term “itinerary information” refers to information generated by the generative information processing apparatus in response to the prompt sentence, including at least proposed schedules, locations, accommodations, transportation options, and cost-related details.

The term “hierarchical structure data” refers to data representing itinerary information in a multi-level structure, in which elements such as days, activities, locations, and costs are organized in nested or related layers for programmatic access.

The term “day-by-day itinerary information” refers to a portion of the hierarchical structure data that specifies, for each day of the travel plan, planned activities, locations, or time slots.

The term “stay-place information” refers to information in the hierarchical structure data representing facilities or locations for overnight stays or prolonged stays, such as lodging or accommodation options.

The term “transportation information” refers to information in the hierarchical structure data representing movement between locations, including transport modes, routes, times, or related details.

The term “cost information” refers to information in the hierarchical structure data representing financial estimates or details, including but not limited to total costs, per-day costs, or itemized costs for accommodation, transportation, and activities.

The term “data formatting processing” refers to processing in which the processor converts hierarchical structure data into display information, including layout organization, labeling, and formatting for presentation on the communication terminal.

The term “display information” refers to data generated by the processor that is configured for visual presentation on the operation screen of the communication terminal, including formatted text, tables, lists, or other visual elements.

The term “evaluation information” refers to information input by the user indicating assessment, acceptance, rejection, or ranking of itinerary information or its components.

The term “revised conditions” refers to updated user conditions, including modified cost conditions, time conditions, or preference conditions, provided by the user in response to previously presented itinerary information.

The term “information-linkage processing” refers to processing in which the processor associates itinerary information with external information sources, such as tourism-resource information, event information, and commercial-facility information, based on one or more linking attributes.

The term “tourism-resource information” refers to information representing sightseeing spots, natural attractions, cultural facilities, or other points of interest relevant to travel activities.

The term “event information” refers to information representing time-bound or date-specific events, such as festivals, performances, exhibitions, or local activities that may be included in an itinerary.

The term “commercial-facility information” refers to information representing commercial entities, such as retail establishments, dining facilities, or service providers, that may be associated with travel activities.

The term “brokerage operations” refers to intermediary operations conventionally performed by human agents or service providers to propose, coordinate, or arrange travel-related plans or services between users and service providers.

The term “movement activities” refers to user activities involving travel or relocation between locations, including leisure travel, business travel, or other forms of trip planning.

The term “regional economic activities” refers to economic activities occurring within a geographic region, including tourism-related commerce, service provision, and associated transactions influenced by user travel behavior.

In one embodiment, a server cooperates with one or more terminals operated by users and with a generative information processing apparatus implementing a generative AI model.

The server includes at least one processor, a memory, a non-volatile storage device, and a network interface. The terminal includes at least a display unit, an input device, and a communication interface. The generative information processing apparatus includes one or more processing units, such as graphics processing units, tensor processing units, or other accelerators, configured to execute a neural network model.

The server executes application software implemented, for example, using a server-side framework such as a generic web framework, and a runtime environment such as a general-purpose scripting environment. The terminal executes client-side software implemented using web technologies such as HTML, CSS, and JavaScript in a web browser, or using components of a mobile operating system in a native or hybrid application. The generative information processing apparatus executes a generative AI model implemented, for example, using a neural network framework such as a general deep-learning library.

The server stores, in the memory or the non-volatile storage device, program modules including at least: a user-interface management module, an input-validation and normalization module, an internal-condition management module, a prompt-generation module, a generative-model interface module, a result-parsing and structuring module, a display-data formatting module, and a feedback-processing module. The memory also stores configuration data and template data for prompt generation, and may store historical logs of user requests and generated itineraries.

The terminal displays, under control of the server, an operation screen that includes input fields for a cost condition, a time condition, and a preference condition. The terminal renders the operation screen using HTML, CSS, and JavaScript. The terminal allows the user to enter, for example, a maximum total budget, a desired travel period, and qualitative preferences such as “hot spring area,” “quiet atmosphere,” “access by train,” or “include local gourmet.”

The terminal packages the entered values as structured information and sends them via a network protocol such as HTTPS to the server.

The server receives the structured information via the network interface and passes it to the input-validation and normalization module. The server performs format checking on the received information by verifying that numeric fields such as budget contain valid numeric values, that date fields can be parsed as valid dates, and that preference fields match expected categories or can be mapped to internal identifiers. The server performs value checking by verifying that the budget is within a configured allowable range, that the travel duration is positive and within permissible limits, and that the combination of cost and time conditions does not violate predefined consistency rules stored in the configuration data.

The server performs normalization processing by converting user-friendly expressions into standardized internal representations. The server may use date-handling libraries to convert relative expressions such as “next month” into explicit start and end dates based on the current system date. The server may map textual preferences such as “hot spring area” or “local gourmet” into internal category codes stored in lookup tables. The server aggregates the validated and normalized fields into internal condition information represented as an internal data structure maintained in the memory. This internal condition information may include, for example, a normalized budget value in a canonical currency, an explicit travel start date and end date, a departure location code, one or more destination-category codes, and one or more activity-category codes.

The server executes the prompt-generation module to transform the internal condition information into a prompt sentence that is optimized for processing by the generative AI model. The server uses template-based document generation by inserting the normalized conditions into one or more natural-language templates stored as template data. The server may also use character-string concatenation processing to append specific instructions controlling the output format or content of the response from the generative AI model. For example, the server may generate a prompt sentence such as:

“The user wants a one-week hot spring trip in Japan next month with a total budget under 100,000 yen, departing from Tokyo. Please propose several detailed travel plans focusing on quiet locations accessible by train, including daily schedules, recommended accommodations, transportation routes, and approximate costs for each day.”

In another example, the server may generate a prompt sentence such as:

“The user requests a three-day family trip for two adults and two children during the next long weekend, with a total budget under 80,000 yen, within three hours by train from Osaka, preferring theme parks and child-friendly hotels. Please generate two detailed itineraries including day-by-day activities, accommodation suggestions, transportation details, and estimated prices.”

The server may include, in the prompt sentence, explicit formatting instructions that cause the generative AI model to output structured content, for example:

“Return the result as a day-by-day itinerary with sections titled ‘Day 1’, ‘Day 2’, etc., and include bullet lists for accommodations, transportation, and main attractions, with approximate costs in yen.”

The server then invokes the generative-model interface module to send the prompt sentence to the generative information processing apparatus. The server constructs a request including the prompt sentence and one or more generation parameters, such as a maximum output length, a sampling temperature, or a number of candidate completions. The server transmits this request over a secure network connection using a protocol such as HTTPS. The generative information processing apparatus receives the request and executes the generative AI model. The generative AI model is, for example, a transformer-based neural network language model having multiple layers of self-attention and feed-forward sub-layers. The generative AI model receives the prompt sentence as tokenized input, where the tokens are mapped to numerical embeddings. The generative AI model propagates the embeddings through a multi-layer architecture in which attention mechanisms compute attention weights between tokens and combine contextual information across the sequence. The generative AI model uses learned weight matrices stored in the accelerators' memory, and computes vector-matrix and matrix-matrix multiplications to produce contextualized embeddings at each layer. The generative AI model then applies a linear output layer and a softmax function to produce probability distributions over a vocabulary for the next token.

The generative information processing apparatus executes an autoregressive generation algorithm in which the generative AI model successively generates output tokens conditioned on the prompt sentence and previously generated tokens. The generative information processing apparatus may use, for example, top-k or nucleus sampling to select the next token at each step under control of the generation parameters provided by the server. The generative information processing apparatus continues this generation until it meets a stopping condition such as a maximum token limit or an end-of-sequence token.

The generative information processing apparatus returns the generated tokens to the server. The generative-model interface module reconstructs the generated tokens into text and passes the result to the result-parsing and structuring module. The server analyzes the generated text in accordance with the formatting instructions included in the prompt sentence. When the generative AI model outputs headings such as “Day 1,” “Day 2,” and bullet lists for accommodations, transportation, and attractions, the server uses rule-based parsing logic and regular expressions to identify sections and list items. The server converts the parsed content into hierarchical structure data, where top-level elements correspond to candidate itineraries, second-level elements correspond to days, and lower-level elements correspond to activities, accommodations, transportation segments, and associated cost values.

The server stores the hierarchical structure data in memory, for example as tree-structured or graph-structured data, and passes the data to the display-data formatting module. The server converts the hierarchical structure data into display information that can be consumed by the terminal. The server may generate structured display metadata including labels, ordering information, and layout hints, which allow the terminal to present each itinerary clearly. For example, the server may mark total cost nodes, highlight nodes associated with user-specified preferences such as “hot spring” or “local gourmet,” and assign identifiers to each day and each itinerary candidate.

The terminal receives the display information from the server and renders it on the operation screen. The terminal may display each itinerary candidate as a separate tab or collapsible panel, and may present day-by-day schedules as separate sections with headings. The terminal may also display cost summaries at the top of each itinerary and provide visual indicators for elements that satisfy strong user preferences.

The user reviews the displayed itineraries and interacts with the terminal to provide evaluation information or revised conditions. The user may, for example, indicate that a certain itinerary exceeds the acceptable budget, that certain activities are undesirable, or that additional preferences such as “include local gourmet” or “avoid long train transfers” should be applied. The terminal sends this evaluation information and revised conditions to the server as additional structured information.

The server receives the evaluation information and revised conditions and passes them to the feedback-processing module. The server updates the internal condition information by, for example, tightening the budget condition, modifying the time condition, or adding preference-condition codes. The server also updates the prompt-generation template and regeneration parameters. The server may generate a new prompt sentence that explicitly incorporates the evaluation information, such as:

“The previous plan exceeded the user's budget and included long train transfers. Please propose new plans under 90,000 yen that limit each single transfer to less than 60 minutes and prioritize local gourmet experiences while keeping a hot spring destination.”

Because the server retains and updates normalized internal condition information, the prompt-generation module can produce prompt sentences that are both more specific and more machine-optimized than prompt sentences that would be directly composed from raw user text. This reduces ambiguity in the interaction with the generative AI model and constrains the search space, thereby improving computational efficiency.

In one embodiment, the generative information processing apparatus is trained using a large corpus of travel-related text, including itineraries, accommodation descriptions, transportation descriptions, and price information. The apparatus performs pre-training by minimizing a prediction error function, such as cross-entropy between predicted tokens and actual tokens, using gradient-based optimization algorithms such as stochastic gradient descent with variants such as Adam. The apparatus updates weight parameters of the transformer architecture by computing gradients via backpropagation, distributing computations across multiple accelerators when applicable. The apparatus may also be fine-tuned on domain-specific datasets emphasizing structured itinerary patterns and explicit day-by-day formatting, which causes the model to more reliably output content that conforms to the structured format desired by the server.

The server may further improve the quality of generated itineraries by applying post-generation re-ranking methods. For example, the generative information processing apparatus may generate multiple candidate outputs for a single prompt sentence. The server may compute scores for each candidate based on rule-based cost aggregation and preference-matching metrics, and may select or combine candidates according to these scores before forming the hierarchical structure data. By executing these additional computations on the server, the system enhances the precision of the generated itineraries and reduces the need for the user to manually discard inferior proposals.

The described configuration provides technical improvements over conventional systems in multiple ways. Because the server performs systematic validation and normalization of user inputs into internal condition information, the server avoids issuing redundant or malformed queries to the generative AI model. This reduces wasted computation on the generative information processing apparatus and decreases network traffic by avoiding repeated trial-and-error interactions. Because the server generates structured prompt sentences that include explicit formatting instructions and constraints, the generative AI model more consistently outputs structured, parseable text, which simplifies downstream parsing and reduces errors in the conversion to hierarchical structure data. This structured approach to prompt generation and parsing represents a non-conventional use of a generative AI model, in which the model is integrated into a controlled data-processing pipeline rather than being used merely as a free-form text generator.

The server also improves the functioning of the user interface by converting the generative AI output into hierarchical structure data before sending it to the terminal. In conventional systems, unstructured text from a model is displayed directly, forcing the terminal or the user to handle unstructured information. In the present system, the server's structuring and formatting operations enable the terminal to present logically separated components, such as day-by-day activities and aggregated costs, thereby reducing cognitive load and facilitating quicker comparison. Because the hierarchical structure is stored in memory, the server can perform efficient algorithmic operations, such as computing differences between itineraries, recomputing cost totals when conditions change, or inserting linked external information such as tourism-resource information or event information at appropriate positions in the structure.

The server can, in certain embodiments, link the hierarchical structure data to external databases containing tourism-resource information, event information, and commercial-facility information. The server may use location identifiers, category codes, or date ranges from the hierarchical structure data to query these external databases, and then insert additional nodes into the structure representing relevant attractions, events, or facilities. This linkage is performed by the server according to predefined matching rules and scoring algorithms, and the results are reflected in the display information sent to the terminal. This results in a technically integrated data structure that combines generated itineraries with structured external data, without requiring manual correlation by the user.

The system's feedback loop, in which the server updates internal condition information and prompt sentences based on user evaluations, also improves computational efficiency and quality. Rather than discarding previous computations, the server uses the historical internal condition information to narrow or adjust subsequent prompt sentences, which reduces unnecessary exploration by the generative AI model. Because the prompt-generation module can encode user dissatisfaction in explicit negative constraints, such as “avoid overnight buses” or “avoid early morning departures,” the generative AI model is guided away from previously rejected patterns. This reduces the number of iterations required to reach a satisfactory itinerary and thereby reduces overall processing time and network usage.

The use of the generative AI model in the system is not a mere automation of human planning operations. The model's transformer-based architecture, learned parameters, and domain-specific fine-tuning allow it to combine heterogeneous data patterns (such as typical travel durations, cost distributions, and attraction sequences) in ways that exceed what a rule-based engine or a simple search engine can achieve efficiently. The server exploits these capabilities by designing prompt sentences and control parameters to leverage the model's internal representation space. The server's intermediate data structures and the model's learned parameters jointly form a technical mechanism that automatically aligns user conditions with plausible itineraries, while preserving machine-parseable structure.

In another embodiment, the server may vary the generative-model parameters based on device characteristics of the terminal or network conditions. For example, when a network connection is unstable or has low bandwidth, the server may adjust the generation parameters (e.g., reduce maximum output length or the number of candidate itineraries) and may also compress or simplify the hierarchical structure data before transmission. In this way, the server reduces communication load while still providing structured and usable itineraries. In yet another embodiment, the generative information processing apparatus may be hosted locally within the same data center as the server, or may be provided as a remote service. When the apparatus is local, the server may use shared-memory interfaces or high-speed interconnects to exchange data. When the apparatus is remote, the server uses standardized application programming interfaces with authentication mechanisms. In both cases, the system's architecture allows the prompt-generation and result-structuring logic to remain independent from the physical deployment of the generative AI model, thereby enabling flexible scaling and load balancing.

The described embodiments demonstrate that the server, the terminal, and the generative information processing apparatus cooperate through specific data structures, control flows, and neural network operations to provide technical improvements in data validation, prompt generation, model interaction, structured parsing, and hierarchical rendering. These improvements result in increased processing speed, improved accuracy and consistency of itineraries, reduced error rates in parsing model outputs, and reduced network and computational load. As a consequence, the system provides a concrete improvement in computer-based travel planning technology and is not limited to an abstract idea of travel planning or a mere automation of human mental processes.

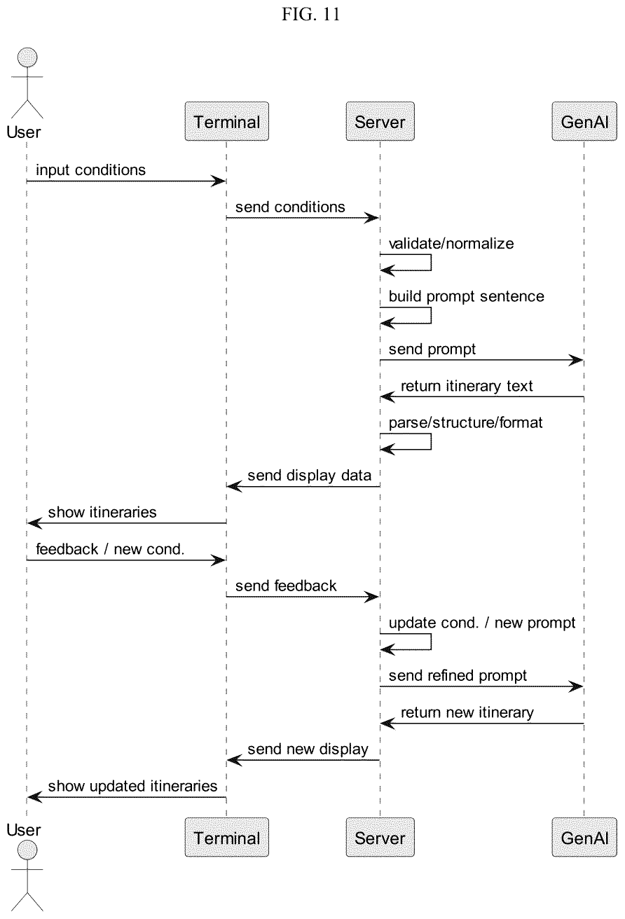

The following describes the processing flow using FIG. 11.

### Step 1:

The terminal displays an operation screen for condition input.

The terminal renders input fields for cost condition, time condition, and preference condition using HTML, CSS, and JavaScript, and presents the fields on a display unit.

The user views the operation screen and enters specific values, such as a maximum total budget, a desired travel period, and qualitative preferences (for example, “hot spring area,” “quiet atmosphere,” “access by train,” “include local gourmet”).

Input: raw user actions on the terminal (keystrokes, taps, clicks).

The terminal converts these actions into internal form field values, performs basic client-side checks (for example, verifying that the budget field contains only digits and that date fields are not empty), and constructs a structured representation of the input in memory.

Output: structured condition data residing on the terminal (for example, a set of key-value pairs representing cost, time, and preferences).

### Step 2:

The terminal transmits the structured condition data to the server.

The terminal serializes the internal key-value pairs into a structured format such as JSON and attaches the serialized data to an HTTP or HTTPS request addressed to an application endpoint on the server.

The terminal sets appropriate headers (for example, a content-type indicating JSON) and sends the request via a communication interface over a network.

Input: structured condition data on the terminal.

The terminal applies a data-packaging operation (serialization) to convert in-memory objects into a byte stream suitable for network transmission, and performs a network transmission operation.

Output: a network request containing the user's conditions reaching the server's network interface.

### Step 3:

The server receives and parses the user's condition data.

The server accepts the HTTP or HTTPS request at a network endpoint and passes the request body to a server-side application module.

The server deserializes the JSON payload or other structured format into an internal data structure, such as a dictionary or an object, using a parsing library associated with the server framework.

Input: serialized structured condition data in the request body.

The server performs a deserialization operation to decode the byte stream into internal memory structures (for example, converting a JSON string into language-native objects) and stores the result in working memory.

Output: internal raw condition data object on the server, including unvalidated cost, time, and preference fields.

### Step 4:

The server validates and normalizes the condition data.

The server executes an input-validation and normalization module to perform format checking by examining each field's type and pattern, verifying that numeric fields are properly formatted, date fields conform to a parsable pattern, and preference fields are of acceptable length or format.

The server performs value checking by comparing numeric values, such as budget or duration, against configured thresholds, and by ensuring that date ranges are logically consistent (for example, start date is before end date).

The server then performs normalization processing, converting user-friendly expressions such as “next month” into explicit date ranges and mapping free-text preferences like “hot spring area” into internal category codes stored in lookup tables.

Input: internal raw condition data object.

The server applies rule-based validation algorithms and mapping functions that transform raw strings and numbers into standardized, canonical representations, discarding invalid entries or replacing them with default values as needed.

Output: normalized and validated internal condition information, including structured fields for budget, explicit dates, preference codes, and other standardized parameters.

### Step 5:

The server aggregates normalized data into internal condition information.

The server combines the normalized cost, time, and preference elements into a single internal condition object, which may include additional derived attributes such as total travel days, inferred region codes, or departure-location identifiers.

The server stores this internal condition object in memory, optionally associating it with a session identifier for the user.

Input: individual normalized fields (budget value, start date, end date, preference codes, and so on).

The server performs data aggregation by grouping and nesting related fields into a cohesive structure, and may compute derived values such as the number of days by subtracting start date from end date.

Output: a consolidated internal condition object representing the user's travel requirements in a machine-optimized form.

### Step 6:

The server generates a prompt sentence for the generative AI model.

The server accesses template data stored in memory and selects a suitable template according to the type of travel scenario implied by the internal condition information (for example, trip length, family vs. solo, domestic vs. international).

The server injects the normalized and derived fields into the template using template-based document generation or character-string concatenation, producing a natural-language prompt sentence that clearly encodes the user's conditions and desired output format.

For example, the server may generate a prompt sentence such as:

“The user wants a one-week hot spring trip in Japan next month with a total budget under 100,000 yen, departing from Tokyo. Please propose several detailed travel plans focusing on quiet locations accessible by train, including daily schedules, recommended accommodations, transportation routes, and approximate costs for each day.”

Input: internal condition object and selected prompt template.

The server executes string-substitution and concatenation operations, inserting numerical values and textual descriptions into placeholder positions, and appends additional instructions about formatting (such as “use headings ‘Day 1’, ‘Day 2’ and bullet lists for accommodations and transportation”).

Output: a finalized prompt sentence in natural-language text, encoded in a character-string representation suitable for submission to a generative AI model.

### Step 7:

The server sends the prompt sentence to the generative information processing apparatus.

The server constructs a request payload containing the prompt sentence and generation parameters such as maximum output length, sampling temperature, and number of candidate outputs.

The server transmits this payload through a network interface using an HTTP or HTTPS request addressed to an API of the generative information processing apparatus.

Input: prompt sentence text and generation parameters.

The server performs serialization of the request payload into JSON or a similar protocol-specific format and initiates a network communication operation to deliver the payload to the generative AI endpoint.

Output: a request received by the generative information processing apparatus, containing the prompt sentence and associated control information.

### Step 8:

The generative information processing apparatus executes the generative AI model to create itinerary text.

The generative information processing apparatus tokenizes the prompt sentence into subword or word tokens using a tokenizer associated with the model, and converts tokens into numeric embeddings via a learned embedding matrix.

The generative information processing apparatus propagates the embeddings through a multi-layer transformer architecture, where each layer applies self-attention and feed-forward transformations parameterized by learned weight matrices and bias vectors.

The generative information processing apparatus calculates attention scores, normalizes them, and computes weighted sums of value vectors, repeatedly across multiple layers, and finally applies a linear projection and softmax operation to produce probability distributions over possible output tokens.

The generative information processing apparatus uses an autoregressive decoding algorithm (for example, greedy decoding or sampling) to iteratively select output tokens, conditioned on the prompt sentence and already generated tokens, until a stop condition is reached.

Input: tokenized representation of the prompt sentence and generation parameters.

The generative information processing apparatus performs numerical tensor operations, including matrix multiplications and non-linear activations, to compute a sequence of output token indices representing the generated itinerary description.

Output: a generated text sequence encoding one or more travel itineraries, returned to the server in a structured response format.

### Step 9:

The server receives and reconstructs the generated text.

The server's generative-model interface module accepts the response from the generative information processing apparatus and extracts the field containing the generated text.

The server converts the token-based or encoded output into a plain-text string if necessary, and passes the string to the result-parsing and structuring module.

Input: encoded generative-model response (for example, token indices or a text field within a JSON object).

The server applies decoding functions provided by the generative AI system or associated libraries to convert encoded representations into a natural-language string.

Output: a textual itinerary description containing headings, lists, and narrative descriptions as produced by the generative AI model.

### Step 10:

The server parses the generated text into hierarchical structure data.

The server scans the text to identify structural markers such as headings (“Day 1,” “Day 2,” etc.), bullet points, and labeled sections for “Accommodation,” “Transportation,” “Main Attractions,” and “Cost.”

The server applies rule-based pattern-matching using regular expressions and delimiter-based splitting to segment the text into logical units and to assign each unit to a corresponding position in a hierarchical data structure (for example, itinerary->day->segment->item).

The server extracts numeric cost values and temporal or location references where possible and stores them as structured attributes in the hierarchical data.

Input: textual itinerary description generated by the generative AI model.

The server executes parsing algorithms that transform unstructured, linear text into a tree- or graph-based representation, tagging nodes with semantic labels (such as “stay-place” or “transportation segment”) and storing associated properties (such as cost or time). Output: hierarchical structure data representing one or more itineraries, with nested elements corresponding to days, activities, accommodations, movements, and cost entries.

### Step 11:

The server formats the hierarchical structure data into display information.

The server passes the hierarchical structure data to the display-data formatting module, which maps nodes and attributes to interface components such as headings, lists, tables, and summary panels.

The server generates display metadata specifying the order of itineraries, labels for each day, font styles for important items (for example, total cost), and layout hints for grouping related information.

Input: hierarchical structure data describing itineraries.

The server performs a mapping operation that converts abstract nodes into a view model, producing a set of display-ready objects that describe what should be shown and how it should be arranged on the terminal's screen.

Output: display information that includes content and layout instructions, ready to be serialized and transmitted to the terminal.

### Step 12:

The server transmits the display information to the terminal.

The server serializes the display information, for example into JSON or another structured format, and sends it as an HTTP or HTTPS response to the terminal.

The server may compress the data if needed to reduce bandwidth usage and may include additional metadata such as caching headers and version tags.

Input: display information object in server memory.

The server performs serialization and network transmission operations to deliver the formatted itinerary data to the client side.

Output: a response received by the terminal containing the structured display information.

### Step 13:

The terminal renders the itineraries to the user.

The terminal's client-side logic receives the response, parses the structured display information, and updates the Document Object Model or corresponding UI framework components.

The terminal displays each itinerary candidate as separate sections, each with day-by-day headings, lists of activities, accommodation details, transportation segments, and associated costs, using CSS styles to emphasize key information.

Input: structured display information delivered from the server.

The terminal performs parsing and UI-binding operations, converting the structured data into visual elements and arranging them on the screen according to layout hints included in the data.

Output: a visually rendered set of itinerary proposals on the operation screen, which the user can read and interact with.

### Step 14:

The user evaluates the displayed itineraries and optionally revises conditions.

The user inspects the day-by-day details, costs, and preferences coverage, and then interacts with input elements (for example, buttons, sliders, text fields) to indicate satisfaction level, to reject specific itineraries, or to adjust conditions such as budget, duration, or additional preferences.

The terminal captures these new inputs as evaluation information and revised conditions and prepares them for resubmission to the server.

Input: user actions on the rendered itinerary interface (such as selecting “too expensive,” entering a new budget, or adding “avoid early morning departures”).

The terminal executes event-handling routines that convert the user's qualitative feedback and modified conditions into structured fields, and aggregates them into an updated condition data object.

Output: structured evaluation information and revised condition data stored on the terminal, ready to be sent to the server.

### Step 15:

The terminal sends feedback and revised conditions to the server for iterative refinement.

The terminal serializes the evaluation information and revised conditions and transmits them to the server via another HTTP or HTTPS request.

The terminal may include a reference identifier linking the feedback to a specific previously displayed itinerary or session.

Input: updated condition data and feedback information in terminal memory.

The terminal performs serialization and network transmission operations to create a feedback request directed to the server's feedback-processing endpoint.

Output: a feedback-containing request received at the server, enabling the server to update internal condition information.

### Step 16:

The server updates internal condition information and regenerates a refined prompt sentence.

The server receives the feedback-containing request and passes the evaluation information and revised conditions to the feedback-processing module.

The server modifies the internal condition object by updating budget constraints, time constraints, and preference codes in accordance with the received feedback (for example, lowering the budget, shortening the duration, adding constraints such as “avoid long transfers,” or adding preferences such as “include local gourmet”).

The server calls the prompt-generation module again, this time generating a refined prompt sentence that explicitly addresses the feedback, such as:

“The previous plan exceeded the user's budget and included long train transfers. Please propose new plans under 90,000 yen that limit each single transfer to less than 60 minutes and prioritize local gourmet experiences while keeping a hot spring destination.”

Input: existing internal condition object and newly received evaluation and revision data.

The server performs update operations on the internal condition object and then re-applies the string-template and concatenation algorithms to create a new prompt sentence that reflects both the original constraints and the user's feedback.

Output: an updated internal condition object and a refined prompt sentence, which the server then uses to repeat the interaction with the generative information processing apparatus as described in previous steps.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented recommendation systems typically rely on fixed-rule filtering or parameterized scoring functions that operate over structured records stored in a database. In such systems, a server generally receives user conditions, executes a simple query over stored facility records, and returns a filtered list to a client terminal. While this architecture is straightforward, it exhibits several technical limitations when handling complex, natural-language user requirements and large, heterogeneous sets of candidate facilities.

First, existing systems are not well suited to interpret nuanced combinations of user conditions, such as cost condition, time condition, and preference condition expressed in free-form language. Backend components frequently treat these conditions as static numeric or categorical filters, leading to rigid query logic and brittle behavior when user input deviates from predefined formats. As a result, the server is often unable to utilize the full information content of the user's natural-language input, which leads to suboptimal ranking of candidate facilities and inefficient use of computation and storage resources.

Second, typical systems do not tightly integrate a generative AI model into the data-processing pipeline in a way that leverages both structured facility information and free-form user conditions. Conventional use of machine learning in recommendation scenarios often treats the model as a black box that directly outputs recommendations from raw signals, or conversely confines the model to isolated tasks such as simple classification. These designs do not exploit prompt-based interaction with a generative model, and therefore cannot dynamically adapt ranking, selection, and explanation behavior based on context-rich prompt sentences that combine pre-filtered candidates and user conditions. As a consequence, semantic reasoning over candidate facility information is underutilized, and server resources are spent executing multiple database queries and additional application-layer heuristics to compensate.

Third, conventional systems lack a robust mechanism to control the structure and format of model outputs at the system level. Generative models that output unstructured text require additional parsing logic on the server, which is error-prone and resource-intensive. In many cases, the server must perform complex post-processing to extract identifiers, names, and reasons from free-form text, causing increased CPU utilization, additional memory allocations, and higher latency. This also makes it difficult to reliably integrate the model output with the facility information storage area, degrading the correctness and reliability of downstream processes such as reservation handling.

Fourth, known systems do not effectively utilize user history and interaction results as part of the generative processing pipeline. Although some systems store logs of user activity, they typically employ ad-hoc scoring adjustments or static user profiles. These approaches do not scale well in terms of prompt construction and do not structurally integrate a history-derived preference feature representation into the generative model's input. As a result, the server cannot systematically improve recommendation quality over time based on historical reservation processes or order processes, leading to redundant data processing and suboptimal personalization.

Fifth, conventional architectures often separate the recommendation engine from transaction processing modules, causing inefficiencies in how selection information, reservations, and orders are coordinated. When the recommendation results are not expressed as machine-readable structured data containing facility identification information, the server must execute extra resolution steps to match textual names to internal identifiers. This additional matching logic introduces further opportunities for error, increases processing time, and complicates the overall control flow between recommendation components and reservation or order components.

Accordingly, there is a need for a computer-implemented system that technically improves the way a server processes user conditions, candidate facility information, and generative AI model outputs. Such a system should: (i) transform heterogeneous inputs into a structured, machine-readable prompt sentence for a generative AI model; (ii) utilize semantic ranking and selection performed by the generative AI model while maintaining deterministic control over output format; (iii) reduce parsing and reconciliation overhead at the server by obtaining structured recommendation results directly from the generative AI model; (iv) integrate history-derived preference feature information into the prompt construction pipeline to systematically personalize recommendations; and (v) streamline the linkage between recommended facilities and downstream reservation or order processing by means of stable facility identification information embedded in the recommendation results. By addressing these technical issues, the system should improve the efficiency, scalability, and reliability of computer resources for generating and delivering personalized facility recommendations.

The specific processing by the specific processing unit 290 of the data processing device 12 in Application Example 1 is realized by the following means.

The present invention provides a server comprising a processor, a storage device, and a communication interface configured to communicate with a user terminal, wherein the processor is configured to generate, on the user terminal acting as a user interface device, a user operation screen for receiving user requirement conditions including a cost condition, a time condition, and a preference condition, and to cause the user operation screen to be presented to a user; to receive, from the user terminal via the communication interface, user input data including the cost condition, the time condition, and the preference condition, to validate and normalize the user input data, and to execute a search process on a facility information storage area of the storage device in order to acquire candidate facility information based on the cost condition, the time condition, and the preference condition; to narrow down the acquired candidate facility information to a predetermined number of candidates and combine the narrowed candidate facility information with the user input data; to construct a prompt sentence as a text sequence including the cost condition, the time condition, the preference condition, and the candidate facility information for input to a generative AI model, and to add constraint information to the prompt sentence to specify an output format and output items of a recommendation result so that the generative AI model outputs structured recommendation data; to transmit, by the communication interface, the prompt sentence as input to the generative AI model, to cause the generative AI model to select, from among the candidate facility information, facilities that match the cost condition, the time condition, and the preference condition, and to cause the generative AI model to generate the recommendation result including, for each selected facility, facility identification information, a recommendation reason, and recommended usage content; to receive, from the generative AI model, the recommendation result, to execute at least one additional query to the facility information storage area of the storage device to acquire detailed facility information corresponding to the facility identification information included in the recommendation result, and to integrate the recommendation result with the detailed facility information to generate presentation information for the user; to transmit the presentation information to the user terminal so that the presentation information is visually displayed in a list format or a detail screen format on the user operation screen; to receive, from the user terminal, selection information including facility identification information of a facility selected by the user and additional conditions including at least one of a number of users and a use time, to execute a reservation process or an order process based on the selection information, and to transmit a processing result of the reservation process or the order process to the user terminal; and to store, in the storage device as history information, the user input data, the recommendation result, and a history of the reservation process or the order process, to generate preference feature information summarizing the history information, and, in subsequent recommendation processing, to add the preference feature information to the prompt sentence to be input to the generative AI model so that the generative AI model generates a personalized recommendation result for each user. This enables the server to technically improve recommendation processing by offloading semantic ranking and explanation generation to the generative AI model under strict format constraints, to reduce parsing and reconciliation overhead through directly obtaining machine-readable structured recommendation data containing facility identification information, to efficiently reuse stored history information as preference feature information in the prompt construction pipeline for enhanced personalization, and to streamline integration between recommendation generation and reservation or order execution, thereby improving overall system performance, scalability, and reliability in computer-implemented facility recommendation scenarios.

The term “system” refers to an arrangement of one or more hardware components and software components, including at least a processor, a storage device, and a communication interface, that cooperate to execute the processing described in the claims.

The term “processor” refers to one or more hardware-based processing units, such as a central processing unit or an execution core, capable of executing instructions to perform data processing, control, and communication operations.

The term “storage device” refers to any non-transitory computer-readable medium, including main memory, auxiliary memory, or other persistent or volatile storage, configured to store program code, facility information, history information, and data used or generated by the processor.

The term “communication interface” refers to hardware and associated control logic that enable data exchange between the system and external devices or services, including at least communication with a user terminal and a generative AI model over one or more networks.

The term “user terminal” refers to an information input/output device, such as a computing device with a display and input capability, that communicates with the server-side processor and presents a user operation screen to a user.

The term “user operation screen” refers to a graphical user interface or equivalent visual presentation displayed on the user terminal, through which the user can input, view, and select information related to requirement conditions, recommendations, reservations, and orders.

The term “user requirement conditions” refers to information indicating constraints and preferences specified by a user, and includes at least a cost condition, a time condition, and a preference condition to be considered in generating a recommendation result.

The term “cost condition” refers to information indicating a monetary constraint specified by a user, such as a maximum cost, price range, or budget per user or per use of a facility.

The term “time condition” refers to information indicating a temporal constraint specified by a user, such as a date, time, time range, or time slot relating to desired use of a facility.

The term “preference condition” refers to information indicating qualitative or quantitative preferences specified by a user, such as desired category, atmosphere, location tendency, or other preferred attributes of a facility or usage scenario.

The term “user input data” refers to data transmitted from the user terminal to the processor, and includes at least the cost condition, the time condition, and the preference condition input by the user through the user operation screen.

The term “validate” refers to processing that checks whether user input data satisfies predetermined rules or formats, such as type constraints, value ranges, and required fields, and identifies or rejects invalid data.

The term “normalize” refers to processing that converts user input data into a standardized internal representation, such as normalizing date and time formats, mapping textual categories to controlled vocabularies, and converting cost values to a standard currency or unit.

The term “facility information storage area” refers to a logical storage region within the storage device, such as one or more database tables or data files, that store facility-related records used for search, recommendation, and reservation processing.

The term “facility information” refers to structured data describing a facility, including at least a facility identifier and one or more attributes such as a name, a category, a location, an average cost, availability, and other operational characteristics.

The term “candidate facility information” refers to facility information that has been retrieved from the facility information storage area as potential candidates based on at least the cost condition, the time condition, and the preference condition.

The term “search process” refers to processing executed by the processor to retrieve candidate facility information from the facility information storage area, including the execution of one or more queries or equivalent data-access operations.

The term “predetermined number of candidates” refers to a specified upper limit on the count of candidate facility records to be subjected to subsequent processing, such as inclusion in a prompt sentence for the generative AI model.

The term “prompt sentence” refers to a text sequence constructed by the processor that includes at least the cost condition, the time condition, the preference condition, and candidate facility information, and that is provided as an input to a generative AI model to cause generation of a recommendation result.

The term “generative AI model” refers to a machine-learned model, such as a generative language model or neural network, configured to process a prompt sentence and to output generated data including at least semantic evaluations, rankings, and textual or structured recommendations.

The term “constraint information” refers to information added to the prompt sentence that specifies an output format, output items, structure, or other constraints for the output of the generative AI model.

The term “structured recommendation data” refers to recommendation result information output by the generative AI model in a machine-readable structured form, such as a key-value list, record array, or other definable data schema including facility identification information and associated attributes.

The term “recommendation result” refers to data generated by the generative AI model based on the prompt sentence, and includes at least one selected facility together with information such as facility identification information, a recommendation reason, and recommended usage content.

The term “facility identification information” refers to data that uniquely or stably identifies a facility within the facility information storage area, such as an internal identifier, code, or key used by the system.

The term “recommendation reason” refers to explanatory information indicating why a given facility was selected as suitable for the user requirement conditions, such as relevance to the cost condition, time condition, and preference condition.

The term “recommended usage content” refers to information indicating how a facility is recommended to be used, such as suggested services, offerings, time frames, or example configurations associated with the facility.

The term “detailed facility information” refers to additional facility information obtained from the facility information storage area, including attributes such as a full name, a location detail, contact information, business hours, or links used for reservations and orders.

The term “presentation information” refers to data prepared by the processor for display to the user, obtained by integrating the recommendation result with detailed facility information, and structured for visualization on the user operation screen.

The term “selection information” refers to information transmitted from the user terminal to the processor indicating at least one facility selected by the user and additional conditions required to perform a reservation process or an order process.

The term “reservation process” refers to processing in which the processor uses selection information to create, modify, or confirm a reservation for a facility, including communication with internal or external reservation systems when applicable.

The term “order process” refers to processing in which the processor uses selection information to create, modify, or confirm an order related to a facility, including communication with internal or external order-management systems when applicable.

The term “processing result” refers to information indicating an outcome of the reservation process or the order process, such as a confirmation, rejection, modification detail, or associated identifiers.

The term “history information” refers to data stored in the storage device that includes at least user input data, recommendation results provided to the user, and records of reservation processes or order processes performed via the system.

The term “preference feature information” refers to data derived by summarizing or transforming history information into a representation of user preferences, tendencies, or patterns suitable for use as part of the prompt sentence.

The term “subsequent recommendation processing” refers to processing for generating a recommendation result for a later request from the same or another user, in which previously generated preference feature information is utilized.

The term “machine-readable structured data” refers to data encoded in a format that can be deterministically parsed and processed by a computing device according to a defined schema, such as a structured representation including a facility identifier, a facility name, a recommendation reason, recommended usage content, and an estimated cost.

In one embodiment, a server cooperates with at least one terminal to implement a facility recommendation system that uses a generative AI model. The server includes a processor, a main memory, a non-transitory storage device, and a communication interface connected to a communication network. The terminal includes a processor, a display device, an input device, a memory, and a communication module. The user operates the terminal to input requirement conditions, to receive recommendation results, and to initiate reservation or order processing.

The server stores, in the storage device, facility information, user history information, and program modules. The facility information is stored in a relational database management system such as a database engine, in one or more tables having fields including a facility identifier, a facility name, a category, a location, an average cost, business hours, and reservation-related parameters. The server also stores a facility information storage area in the form of indexed tables to support efficient search based on cost, time, and preference attributes.

The server executes, on the processor, a web application program implemented using server-side software such as an application framework or an equivalent environment. The server also executes a prompt construction module and a recommendation orchestration module, each implemented as software components that run on the processor. The server accesses an external generative AI model via an API over the communication interface, or in another embodiment, the server locally executes the generative AI model using an accelerator such as a graphics processing unit.

The terminal executes an application program implemented, for example, as a native mobile application or a web-based application running in a browser engine. The terminal displays a user operation screen on the display device. The terminal presents, on the user operation screen, input fields for a cost condition, a time condition, and a preference condition. The user operates the terminal to enter free-form natural-language text such as “Budget is 3000 yen, tomorrow evening, Italian near the main station, quiet atmosphere.” The terminal converts the user input into internal variables and transmits user input data to the server via the communication module.

The server receives the user input data through the communication interface. The server parses the received text using a natural-language preprocessing module executed on the processor. The server applies tokenization, regular-expression matching, and rule-based parsing to extract cost expressions, temporal expressions, and preference keywords. The server uses a date-time parsing library to normalize temporal expressions (for example, converting “tomorrow evening” into a specific date and time range) and uses numeric parsing functions to normalize budget expressions (for example, converting “3000 yen” into a numeric cost value in a standard unit). The server thereby validates and normalizes the user input data and stores normalized values in memory as structured data objects.

The server executes a search process on the facility information storage area. The server formulates parameterized queries that constrain the average cost field based on the normalized cost condition, constrain availability fields based on the normalized time condition, and constrain category and location fields based on the preference condition. The server uses indexes on the facility identifier, category, and cost fields to reduce the number of disk accesses and to minimize query latency. The server obtains candidate facility information in the form of multiple facility records satisfying coarse filtering conditions. The server stores these candidate records in memory as a list of structured objects.

The server narrows down the candidate facility information to a predetermined number of candidates, for example by limiting to the top N facilities according to a simple scoring function or distance metric computed on the processor. The server converts each selected candidate facility record into a concise textual description that can be embedded into a prompt sentence. For example, the server generates a description such as “Facility ID: 101, Name: Italian Bistro A, Area: Central District, Average Cost: 2500 yen, Atmosphere: quiet, Suitable for: casual dinner.”

The server constructs a prompt sentence to be input to the generative AI model. The server combines the user requirement conditions and the textual descriptions of the candidate facility information into a single text sequence. In one example, the server constructs a prompt sentence as follows:

“The user's budget is 3000 yen, the desired time is tomorrow evening, and the user prefers Italian cuisine near the main station with a quiet atmosphere. From the following facility candidates, select up to 5 facilities that best match these conditions, and for each facility provide: facility identifier, facility name, reason for recommendation, recommended usage (such as menu examples or use scenes), and estimated cost per person. Facility candidate 1: Facility ID: 101, Name: Italian Bistro A, Area: Central District, Average Cost: 2500 yen, Atmosphere: quiet. Facility candidate 2: Facility ID: 205, Name: Trattoria B, Area: East District, Average Cost: 2800 yen, Atmosphere: lively. Facility candidate 3: Facility ID: 312, Name: Cafe C, Area: Central District, Average Cost: 2200 yen, Atmosphere: relaxed.”

The server appends constraint information to the prompt sentence to ensure that the generative AI model outputs machine-readable structured recommendation data. The server adds explicit formatting instructions such as:

“Output the recommendations in the following structured format. For each recommended facility, output a single line in the form: ‘Facility ID: <id>; Name: <name>; Reason: <short explanation>; RecommendedUsage: <short description>; EstimatedCostPerPerson: <numeric value>’. Do not output any text that is not part of this format.”

The server transmits the constructed prompt sentence to the generative AI model via the communication interface. In one embodiment, the generative AI model is a transformer-based neural network trained as a generative language model. The model architecture includes an embedding layer, multiple self-attention layers, feedforward layers, and a token decoding mechanism. The model receives the prompt sentence as a sequence of tokens, converts each token into an embedding vector, and processes the token sequence through stacked attention layers. The model computes attention weights over positions corresponding to user requirement conditions and candidate facility descriptions. The model internally represents semantic relationships between the cost condition, the time condition, the preference condition, and textual attributes of each candidate facility.

The generative AI model executes, on specialized hardware such as a graphics processing unit, parallel matrix multiplication operations to propagate activations through the self-attention and feedforward layers. The model is trained in advance using a training dataset that includes natural-language descriptions and structured annotations. The model parameters, including weight matrices and bias vectors, are optimized using a gradient-based learning algorithm such as stochastic gradient descent with backpropagation. During training, the model minimizes a loss function such as a cross-entropy loss between predicted tokens and target tokens. The model optionally employs data augmentation and regularization techniques to improve generalization.

During inference in the present system, the model does not retrain but executes forward propagation to generate output tokens. The server sets decoding parameters such as a temperature value, a maximum token length, and a stopping condition. The model generates text tokens that follow the instruction in the prompt sentence and produce a list of recommended facilities in the specified structured format. Because the prompt sentence includes explicit facility identifiers and format constraints, the model is guided to output facility identification information and to avoid uncontrolled free-form responses.

The server receives the output text from the generative AI model via the communication interface. The server parses the output according to the predefined structured format. The server splits the output text into lines and extracts fields by detecting delimiters such as “Facility ID:” and “Reason:”. The server converts the extracted facility identifiers into internal numeric identifiers and verifies that each identifier corresponds to an existing record in the facility information storage area. The server discards any line that does not conform to the expected pattern or that references a non-existing facility. The server thus reduces parsing errors and normalizes the recommendation result into internal data structures.

The server retrieves detailed facility information from the facility information storage area using the verified facility identifiers. The server executes parameterized queries to obtain attributes such as a full address, contact information, detailed business hours, and reservation URLs. The server combines the recommendation result received from the generative AI model, which includes recommendation reasons and recommended usage content, with the detailed facility information. The server constructs presentation information objects that contain all data required to render a list view and a detail view on the terminal.

The terminal receives presentation information via the communication module. The terminal parses the received data and updates the user operation screen. The terminal displays, for each recommended facility, the facility name, the estimated cost, the recommendation reason, and a brief description of recommended usage. The user can select any recommended facility to view detailed information and to initiate a reservation or order.

The user operates the terminal to select one facility and to specify additional conditions such as a number of users and a desired use time. The terminal transmits selection information to the server. The server receives the selection information and initiates a reservation process or an order process. The server may communicate with external reservation systems or order-management systems via the communication interface, using facility identification information and user-specified parameters. The server receives a processing result from the external system and returns a confirmation to the terminal. The terminal displays confirmation information on the user operation screen.

The server stores, in the storage device, history information including user input data, recommendation results, and reservation or order outcomes. The server executes a history analysis module that runs on the processor. The server aggregates past actions per user and computes preference feature information. The server may represent user preferences as a vector of weighted attributes such as typical budget range, frequently selected categories, and preferred areas. The server may compute such a vector by counting occurrences, applying weighting factors, and normalizing values.

The server integrates the preference feature information into subsequent prompt sentences. For example, the server augments a new prompt sentence with a sentence such as:

“Based on past history, this user tends to prefer quiet facilities in the central district with a budget between 2500 and 3500 yen and often selects Italian or Japanese cuisine. Please take these preferences into account when ranking the facility candidates.”

The server inserts this additional context into the prompt sentence before the facility candidate list. As a result, the generative AI model receives not only the current cost condition, time condition, and preference condition, but also a summary of the user's past behavior. The model thus computes attention over both current conditions and historical preferences, which improves the relevance of selected facilities.

This configuration produces technical effects that improve computer technology beyond mere automation of human decision-making. The server reduces the number of candidate facilities to a predetermined number before generating the prompt sentence, which reduces the token length and thus reduces processing time and memory usage in the generative AI model. The explicit inclusion of facility identifiers and strict format constraints in the prompt sentence causes the generative AI model to output structured recommendation data that can be parsed deterministically, which reduces CPU overhead and parsing errors compared to handling unstructured natural-language outputs. The integration of preference feature information into the prompt sentence enables the model to produce more accurate and stable recommendations with fewer iterations, which reduces network communication between the server and the generative AI model and improves overall throughput.

The server uses a dataflow in which pre-filtering, prompt construction, model inference, and post-processing are tightly coupled. This dataflow is not a generic listing of data retrieval and display steps but an orchestrated sequence that controls where and how the generative AI model is applied. The server performs initial filtering and candidate narrowing using database capabilities, which ensures that the generative AI model receives a limited and focused context. The generative AI model then performs semantic ranking and explanation generation under strict constraints, which is a task that is difficult to perform using conventional rule-based or human processes. The server finally reconciles the structured output with the facility information storage area using facility identifiers, guaranteeing data consistency between the recommendation layer and the reservation or order layer.

In another embodiment, the server executes the generative AI model locally rather than through an external API. The server stores model parameters on the storage device and loads them into memory. The server uses a hardware accelerator to execute matrix operations corresponding to self-attention and feedforward layers. The server may fine-tune the generative AI model using a fine-tuning dataset containing anonymized user requirement conditions, facility candidate descriptions, and desired structured outputs. The server minimizes a loss function defined over the structured output fields using gradient descent, updating model weights to better follow the specified output format and to better exploit facility identifiers. This fine-tuning further reduces output errors and improves processing efficiency at inference time.

In yet another embodiment, the server uses different prompt construction strategies for different terminal types. For a mobile terminal with limited bandwidth, the server may reduce the number of candidate facilities included in the prompt sentence and request only a small number of top recommendations from the generative AI model. For a high-resolution terminal, the server may include additional attributes such as user reviews or distance metrics in the candidate descriptions and request more detailed explanations. In each case, the server adaptively controls prompt length and output volume to balance recommendation quality and system resource usage.

The terminal may also support voice input as an alternative to text input. In this case, the terminal executes a speech recognition module to convert spoken user requirement conditions into text. The server then processes the recognized text in the same manner as manual text input. This variation does not change the fundamental flow of prompt sentence construction, generative AI model interaction, and structured output processing.

By structuring the system as described above, the server improves the way computing resources are used for recommendation generation. The server reduces computational load on the generative AI model through candidate narrowing, decreases communication overhead through concise prompt sentences, and minimizes parsing and reconciliation work by obtaining structured outputs. The integration of history-derived preference feature information into prompt sentences enhances accuracy and personalization without increasing the complexity of server-side rule sets. Consequently, the system realizes improved speed, precision, and robustness in facility recommendation processing, and provides a concrete improvement in computer technology rather than a mere automation of a human selection task.

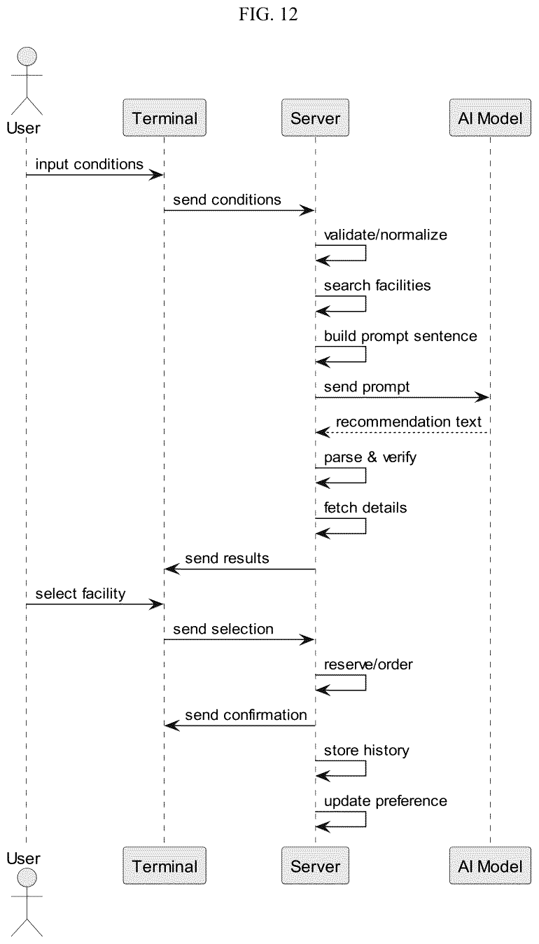

The following describes the processing flow using FIG. 12.

### Step 1:

The terminal displays a user operation screen and receives user requirement conditions.

The terminal generates an input form on the display, allocates UI components for a cost condition, a time condition, and a preference condition, and initializes internal variables to store user input. The user operates the terminal to input text such as “Budget is 3000 yen, tomorrow evening, Italian near the main station, quiet atmosphere.” As input, the terminal receives raw character strings from the keyboard or touch interface. The terminal performs basic client-side checks, such as verifying that mandatory fields are not empty, and outputs structured user input data containing the raw text for each field and a timestamp, which the terminal then transmits to the server via a communication module.

### Step 2:

The server receives the user input data and performs validation and normalization.

The server accepts, as input, the structured user input data transmitted from the terminal, including the cost condition string, the time condition string, and the preference condition string. The server parses these strings using tokenization and pattern-matching operations to detect numeric values, currency units, date expressions, and keyword phrases. The server executes numeric parsing to convert “3000 yen” into a numeric budget value in a standard unit, and executes date-time parsing to convert “tomorrow evening” into a concrete date and time range. The server also removes illegal characters and trims whitespace. Based on these operations, the server outputs normalized user requirement conditions in a structured format, including a numeric budget, a normalized time interval, and a set of standardized preference attributes.

### Step 3:

The server executes a search process to retrieve candidate facility information.

The server receives, as input, the normalized user requirement conditions. Using these conditions, the server constructs one or more database queries that filter facility records by average cost, available time slots, category, and location. The server executes these queries against a facility information storage area that contains indexed facility records. During query execution, the server uses range comparisons for cost and time and equality or similarity checks for categories and locations. The server collects the resulting records and applies additional in-memory filtering to remove facilities that do not satisfy required attributes. The server outputs a list of candidate facility information objects, each including at least a facility identifier, name, category, area, average cost, and basic descriptive attributes.

### Step 4:

The server narrows down candidate facilities and prepares textual descriptions.

The server receives, as input, the list of candidate facility information objects. The server computes a preliminary score for each candidate using a simple heuristic function that may combine distance from a target location, difference between average cost and user budget, and match degree of preference keywords. The server sorts the candidates according to this score and selects up to a predetermined number, for example the top 20. For each selected facility, the server generates a concise textual description such as “Facility ID: 101, Name: Italian Bistro A, Area: Central District, Average Cost: 2500 yen, Atmosphere: quiet.” The server thereby transforms structured facility records into human-readable description strings. The server outputs a narrowed candidate set along with the associated description strings.

### Step 5:

The server constructs a prompt sentence for the generative AI model.

The server receives, as input, the normalized user requirement conditions and the textual descriptions of the narrowed candidate facilities. The server concatenates the user conditions into an introductory instruction section, for example: “The user's budget is 3000 yen, the desired time is tomorrow evening, and the user prefers Italian cuisine near the main station with a quiet atmosphere.” The server then appends task instructions that define what the generative AI model should do and specify the required output fields, such as: “From the following facility candidates, select up to 5 facilities that best match these conditions, and for each facility provide: facility identifier, facility name, reason for recommendation, recommended usage, and estimated cost per person. Output each facility in the format: ‘Facility ID: <id>; Name: <name>; Reason: <text>; RecommendedUsage: <text>; EstimatedCostPerPerson: <number>’.” After that, the server appends all candidate descriptions under labels such as “Facility candidate 1: . . . ”. In this way, the server converts structured data and parameters into a single continuous text sequence. The server outputs a complete prompt sentence that encodes user conditions, facility candidates, and output constraints.

### Step 6:

The server transmits the prompt sentence to the generative AI model and triggers inference.

The server receives, as input, the constructed prompt sentence. The server encapsulates the prompt sentence into a request message for a generative AI model inference API, sets control parameters such as maximum output length and temperature, and sends the request via the communication interface. The generative AI model receives the prompt sentence as text, tokenizes it into discrete tokens, and converts each token into an embedding vector. The model then performs matrix multiplications and attention computations across multiple transformer layers to generate context-aware token representations. Based on these internal calculations, the model decodes a sequence of output tokens that form text lines describing recommended facilities according to the specified format. The server receives the generated text as output from the generative AI model.

### Step 7:

The server parses the generated recommendation result and verifies facility identifiers.

The server takes, as input, the raw output text produced by the generative AI model. The server splits the text into lines, and for each line, the server applies string operations to locate labels such as “Facility ID:”, “Name:”, “Reason:”, “RecommendedUsage:”, and “EstimatedCostPerPerson:”. The server extracts substring segments following each label, converts extracted numeric values to numeric types, and converts facility IDs to internal identifier types. The server checks that each parsed facility identifier exists in the facility information storage area by executing a simple lookup query. If a line is malformed or contains an invalid facility identifier, the server discards that line. Through this parsing and verification, the server transforms unstructured output text into validated structured recommendation objects. The server outputs a cleaned list of recommendation entries, each including a facility identifier, name, recommendation reason, recommended usage content, and estimated cost per person.

### Step 8:

The server enriches recommendation entries with detailed facility information.

The server receives, as input, the list of validated recommendation entries. For each entry, the server uses the facility identifier to query the facility information storage area for detailed attributes, including address, contact information, business hours, reservation URL, and additional descriptive fields. The server executes parameterized queries and uses efficient primary-key index lookups to minimize retrieval time. The server merges each recommendation entry with the corresponding detailed facility record to form a comprehensive presentation object. As output, the server produces a set of enriched recommendation objects containing both model-generated information and authoritative facility data.

### Step 9:

The server generates presentation information and transmits it to the terminal.

The server receives, as input, the enriched recommendation objects. The server formats these objects into a data structure suitable for transmission, including grouping fields into sections used for list items and detail views. The server may sort the enriched recommendations by an overall score that combines the model's implicit ranking and the server's additional rules, such as promoting facilities with confirmed availability. The server then encodes the structured data into a message and sends it through the communication interface to the terminal. The output from this step is presentation information that contains all details required by the terminal to render the recommendation list and detailed screens.

### Step 10:

The terminal displays the recommendation list and accepts user selection.

The terminal receives, as input, the presentation information sent by the server. The terminal parses the structured data and populates internal view-model objects. The terminal then updates the user operation screen to show a scrollable list of recommended facilities, with each list item displaying key elements such as the facility name, estimated cost, and a short recommendation reason. The user operates the terminal to tap a desired facility to view more details. Upon the user's selection, the terminal displays a detailed screen showing additional attributes like address and business hours, and provides control elements for initiating a reservation or order. The terminal outputs user selection data, including the selected facility identifier and any further user input such as number of users and desired time.

### Step 11:

The server processes selection information to execute a reservation or order.

The server receives, as input, the selection information from the terminal, including the facility identifier and additional conditions. The server validates the selection by checking that the requested time slot aligns with the facility's business hours and that the requested number of users does not exceed capacity fields in the facility record. The server then constructs a request to an internal reservation module or an external reservation or order-management system, including the facility identifier and user-specific parameters. The server sends this request through the communication interface, receives a processing result such as a confirmation code or rejection reason, and sets a reservation status accordingly. The server outputs a reservation result object containing the status, confirmation information, and summary details, and returns it to the terminal.

### Step 12:

The terminal displays the reservation result and stores confirmation information.

The terminal receives, as input, the reservation result object from the server. The terminal parses the result and updates the user operation screen to display confirmation information, including facility name, reserved date and time, number of users, and any confirmation code.

The terminal may also store the confirmation details in local storage for later reference by the user. The output from this step is a visual confirmation shown to the user and an updated local record on the terminal indicating the successful reservation or order.

### Step 13:

The server records history information and derives preference feature information.

The server takes, as input, the normalized user requirement conditions, the structured recommendation result, and the reservation result. The server writes these data items into a history storage area using structured records keyed by user identifier and timestamp. The server then executes an analysis routine that aggregates multiple past records per user. The server calculates frequency counts and averages for attributes such as typical budget, frequently selected categories, and preferred areas, and encodes these values into a preference feature vector. The server optionally normalizes this vector so that each dimension represents a weight between predetermined bounds. As output, the server stores preference feature information associated with the user, which will be used in subsequent prompt sentence construction.

### Step 14:

The server incorporates preference feature information into future prompt sentences.

The server receives, as input, the latest preference feature information alongside new user requirement conditions for a later session. Before constructing a new prompt sentence, the server generates an additional explanatory sentence summarizing the user's past tendencies, such as “Based on past history, this user tends to prefer quiet facilities in the central district with a budget between 2500 and 3500 yen and often selects Italian cuisine.” The server then inserts this summary into the new prompt sentence before listing the candidate facilities. By adding this context, the server modifies the input to the generative AI model so that the model's internal attention mechanisms can consider both current and historical preferences.

The output from this step is an enhanced prompt sentence that embeds explicit personalization information, which leads to more accurate and efficient recommendation results in subsequent inference by the generative AI model.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional travel-planning and reservation systems largely operate as siloed workflow engines that merely collect user input, forward queries to external information services, and display raw or minimally processed results. In such systems, a processor in a server typically executes fixed, rule-based logic to query transportation information services and reservation services. This architecture presents several technical problems in terms of computer technology itself.

First, conventional systems perform fragmented processing for acquisition, comparison, and selection of transportation options. The processor often issues multiple independent requests to external information providers and then applies ad hoc filtering on the client side or in separate application modules. As a result, the system cannot efficiently normalize heterogeneous time data, cost data, and constraint conditions into a unified internal representation. This leads to redundant computations, inefficient memory usage, and increased processing latency when handling multiple candidate routes and pricing structures. Second, traditional systems lack an integrated mechanism for adaptive optimization of selection algorithms based on past operational data. Even when past travel or reservation records exist in a storage device, they are typically used only for simple statistical reporting or static recommendation, and are not structurally fed back into the core algorithm that selects transportation options. Consequently, the processor cannot dynamically adjust parameter weights or scoring logic in view of observed user behavior and historical performance, which limits the ability of the system to improve selection accuracy and computational efficiency over time.

Third, existing solutions do not provide a unified processing framework in which generative artificial intelligence models are tightly integrated with the server-side decision pipeline. In many implementations, a generative model, if used at all, is invoked only at the presentation layer to generate textual descriptions, without leveraging the structured movement conditions and movement candidate information maintained in the server. This results in duplicated data representations between the server logic and the generative model, introduces additional data transfer overhead, and prevents the model from contributing to core computational tasks such as route evaluation and plan synthesis.

Fourth, conventional systems do not coordinate reservation processing and user notification as part of a single, transactionally consistent server operation. Reservation APIs of external providers are accessed in an ad hoc manner, and notification messages are often generated in separate subsystems or at the terminal side. This separation causes difficulties in maintaining coherent state between stored movement conditions, selected options, reservation identifiers, and user-visible notifications. It can also lead to inconsistent error handling, increased network chatter, and higher failure rates in end-to-end workflows.

Accordingly, there is a need for an improved server architecture and processing method that:

(i) centrally manages movement conditions and movement candidate information as normalized structured data, (ii) applies a unified scoring algorithm whose parameters are updated based on past movement and reservation performance data, (iii) integrates generative artificial intelligence models through prompt sentences derived directly from server-maintained structured data, and (iv) automates reservation processing and notification delivery in a coordinated, state-aware manner. By addressing these issues at the server and processor level, the invention aims to improve the efficiency, scalability, and adaptability of computer-implemented travel-planning and reservation operations, thereby constituting a concrete improvement in computer technology related to information processing, external service integration, and intelligent decision support.

The specific processing by the specific processing unit 290 of the data processing device 12 in Example 2 is realized by the following means.

The present invention provides a server comprising a processor and a storage device, the processor being configured to provide an information input/output interface by which a user inputs movement conditions including schedule information, location information, time information, and cost conditions; store, in an information storage area of the storage device, structured data representing the movement conditions acquired via the information input/output interface; transmit, based on the movement conditions stored in the information storage area, inquiry data to external information providing devices that supply route information providing services and fare information providing services, and obtain movement candidate information including required time information, fare information, and time information for each movement means; perform normalization processing, comparison processing, and evaluation processing on the obtained movement candidate information based on the time information, the fare information, and constraint conditions included in the movement conditions, and select an optimal movement means by using a scoring algorithm; transmit reservation request data corresponding to the selected movement means to an external reservation service, receive reservation identification information and reservation detail information from the external reservation service, and store the reservation identification information and the reservation detail information in the information storage area to automatically execute reservation processing for the movement means; generate a notification message based on the reservation detail information and provide the reservation detail information to a user terminal via an electronic mail transmission service or a notification distribution service; generate a prompt sentence, which instructs processing contents to a generative artificial intelligence model, based on the movement conditions and the movement candidate information stored in the information storage area, input the prompt sentence into the generative artificial intelligence model to obtain proposal information related to a movement plan, and convert the proposal information into output data for presentation to the user; and further use past movement performance data and past reservation performance data stored in the information storage area as learning data to perform similarity evaluation and trend analysis with respect to the movement conditions of the user, and update weighting parameters of the scoring algorithm based on results of the similarity evaluation and the trend analysis. This enables centralized and normalized handling of heterogeneous movement conditions and movement candidate information, adaptive improvement of the scoring algorithm using stored operational data, tight server-side integration of a generative artificial intelligence model through prompt sentences derived from structured data, and coordinated execution of reservation processing and user notification, thereby improving processing efficiency, scalability, and decision quality of computer-implemented travel-planning and reservation operations.

The term “processor” refers to a hardware-based information processing unit, such as a central processing unit or a programmable logic circuit, that executes instructions to perform arithmetic, logical, control, and input/output operations required to implement the functions of the system.

The term “storage device” refers to a hardware-based data retention component, such as a magnetic storage medium, a semiconductor memory, or a solid-state storage medium, that stores programs, structured data, and operational information used by the processor.

The term “information storage area” refers to a logical storage region provided in the storage device, in which structured data including movement conditions, movement candidate information, reservation information, and historical performance data is stored and managed.

The term “user terminal” refers to an information processing apparatus operated by a user, such as a portable communication device, a personal computing device, or a display-equipped input device, that communicates with the server and presents information to the user.

The term “information input/output interface” refers to a functional interface, including graphical user interface components or programmatic input/output endpoints, by which the user terminal and the server exchange data representing movement conditions and by which information is presented to the user.

The term “movement conditions” refers to a set of parameters relating to a desired movement of a user, including at least schedule information, location information, time information, and cost conditions, which are used as input for computing transportation options.

The term “schedule information” refers to temporal specification data indicating a date or date range during which the user intends to perform a movement.

The term “location information” refers to spatial specification data indicating an origin location, a destination location, or one or more intermediate locations associated with the movement.

The term “time information” refers to temporal constraint data associated with the movement, including at least desired departure time or desired arrival time for a transportation segment.

The term “cost conditions” refers to economic constraint data related to the movement, including at least a maximum allowable cost, preferred cost range, or cost-related preferences specified by the user.

The term “structured data” refers to data represented in a predefined, machine-readable format, such as records, fields, keys, and values, enabling the processor to systematically store, retrieve, and manipulate the data.

The term “external information providing device” refers to an external system, such as a remote server or service platform, that provides route information, fare information, or other transportation-related data via a communication network.

The term “route information providing service” refers to a service executed by an external information providing device that supplies information about one or more possible routes between locations, including at least path data and required time data.

The term “fare information providing service” refers to a service executed by an external information providing device that supplies price-related information for transportation options, including at least base fares, additional charges, or estimated total costs.

The term “communication protocol” refers to a predefined set of rules and formats governing the exchange of data over a communication network between the server and the external information providing devices.

The term “movement candidate information” refers to data sets representing one or more candidate transportation options produced in response to the movement conditions, including at least required time information, fare information, and time information for each movement means.

The term “required time information” refers to quantitative data indicating a duration needed for a transportation option to complete a movement between specified locations.

The term “movement means” refers to a transportation modality or method, such as a land transport means, a water transport means, or an air transport means, that can be used for moving a user or goods between locations.

The term “normalization processing” refers to data processing that converts heterogeneous or differently scaled values of required time information, fare information, and constraint conditions into a common or standardized representation suitable for comparison and evaluation.

The term “comparison processing” refers to data processing in which two or more movement candidate information items are contrasted with each other based on one or more criteria, such as required time, cost, or constraint satisfaction.

The term “evaluation processing” refers to data processing that assigns a quantitative or qualitative assessment to each movement candidate information item based on predefined criteria and constraint conditions.

The term “scoring algorithm” refers to a computational procedure that calculates a score value for each movement candidate information item by combining normalized parameters, such as required time and cost, according to weighting parameters or other evaluation rules.

The term “reservation request data” refers to structured data transmitted from the server to an external reservation service, including at least information identifying a selected movement means, schedule information, location information, and user-related reservation parameters.

The term “external reservation service” refers to a service executed by an external system that performs reservation processing for transportation, lodging, or related services on the basis of reservation request data received from the server.

The term “reservation identification information” refers to data output from the external reservation service that uniquely identifies a completed reservation, such as a reservation code, booking identifier, or confirmation number.

The term “reservation detail information” refers to data describing attributes of a completed reservation, including at least schedule information, location information, movement means, seat or service class, and total cost.

The term “notification message” refers to a data structure generated by the processor that includes at least part of the reservation detail information and is configured for delivery to the user terminal via a communication channel.

The term “electronic mail transmission service” refers to a message delivery system that transmits electronic mail messages over a communication network, using standardized mail protocols, from the server to an address associated with the user.

The term “notification distribution service” refers to a push-type or pull-type message service, such as a push notification service or in-application messaging service, that delivers notification messages from the server to the user terminal.

The term “generative artificial intelligence model” refers to a machine-executed model, implemented by software and hardware resources, that generates new data or content, such as textual data, in response to input data, based on machine-learned parameters.

The term “prompt sentence” refers to structured input data, usually expressed as natural language text or a combination of text and control tokens, that specifies instructions, conditions, or context to be processed by the generative artificial intelligence model.

The term “proposal information” refers to result data generated by the generative artificial intelligence model in response to the prompt sentence, including one or more candidate movement plans, explanations, or recommendations derived from the movement conditions and movement candidate information.

The term “output data for presentation” refers to data that has been converted or formatted by the processor into a form suitable for display or rendering on the user terminal, including textual, graphical, or interactive elements representing the proposal information.

The term “past movement performance data” refers to historical data representing previous movements executed by users, including at least realized routes, required times, costs, and associated conditions.

The term “past reservation performance data” refers to historical data representing completed reservation operations, including reservation identification information, reservation detail information, and associated movement conditions.

The term “similarity evaluation” refers to a computational process in which the processor evaluates degrees of similarity between current movement conditions and past movement performance data or past reservation performance data according to predefined similarity metrics.

The term “trend analysis” refers to a computational process in which the processor identifies patterns or tendencies over time in past movement performance data or past reservation performance data, such as recurring preferences or cost-time trade-offs.

The term “weighting parameters” refers to numerical factors used by the scoring algorithm to adjust the relative importance of different evaluation criteria, such as required time and cost, when calculating scores for movement candidate information.

The term “regional information providing service” refers to a service executed by an external system that supplies information related to a particular region, including at least sightseeing information, event information, and facility information.

The term “sightseeing information” refers to data describing points of interest, attractions, or sightseeing spots in a region relevant to a movement plan.

The term “event information” refers to data describing scheduled activities, performances, exhibitions, or other time-bound events occurring in a region.

The term “facility information” refers to data describing facilities such as accommodations, dining places, cultural sites, or transport hubs that can be utilized in connection with a movement plan.

The term “comprehensive movement plan information” refers to integrated output data that combines reservation information for an optimal movement means with associated regional information, including sightseeing information, event information, and facility information, to present a unified plan to the user.

In one embodiment, a server cooperates with a terminal and a user to implement the invention.

The server includes at least one processor, a main memory, a non-volatile storage device, and a network interface. The server executes system software such as an operating system and middleware, and executes application software implementing the movement-planning and reservation functions. The server may be implemented on a general-purpose computing platform such as a rack-mounted computer, a virtual machine in a cloud computing environment, or a containerized application, and may run software such as a web server, an application framework, and a database management system. For example, the server may run a web server process, an application framework such as a scripting-language-based framework or an object-oriented-language-based framework, and a relational database system such as a structured query language database engine. These names are illustrative examples, and the invention is not limited to specific products.

The terminal includes an information processing unit, a display device, an input device, and a communication module. The terminal may be, for example, a portable information processing apparatus, a stationary information processing apparatus, or a tablet-type apparatus, executing a web browser or a dedicated application. The terminal communicates with the server via a communication network such as a packet-switched network. The terminal displays input screens for movement conditions and displays proposal information and reservation detail information received from the server.

The user operates the terminal to input movement conditions. The user specifies at least schedule information, location information, time information, and cost conditions using input fields, selection controls, and interactive components presented on the terminal display. The terminal transmits these movement conditions to the server as structured data. The server receives the movement conditions and stores them in a storage device as records in an information storage area managed by a database management system. The server represents the movement conditions as structured data tuples in a table, such as a movement_conditions table, with fields corresponding to date, origin, destination, desired departure time, maximum cost, and user identifier.

The server accesses external information providing devices to obtain movement candidate information. The server uses a network interface and an HTTP client library to send requests to route information providing services and fare information providing services. The server converts the movement conditions into parameters suitable for these services, such as origin coordinates, destination coordinates, and departure timestamps. The server receives response data in a structured format, parses the data, and extracts movement candidate information. The movement candidate information includes, for each candidate movement means, at least required time information, fare information, departure time information, and arrival time information. The server stores these movement candidate information items in an information storage area, for example as rows in a movement_candidates table, linking each candidate to a movement conditions record via a foreign key.

The server performs normalization, comparison, and evaluation processing on the stored movement candidate information. The server normalizes required time and cost values by converting them into internal units and scaling them to a unified numerical range. The server represents each candidate as a feature vector, for example, including normalized duration, normalized cost, departure time deviation from the user's desired time, and additional attributes such as number of transfers or reliability scores. The server then applies a scoring algorithm implemented as program instructions executed by the processor. The server computes, for each candidate, a score that is a weighted combination of the features. The server stores the scores in the movement_candidates table or a related table. The server then selects, as an optimal movement means, one or more candidates having extremal scores based on predetermined selection criteria.

The server uses past movement performance data and past reservation performance data to adaptively adjust the scoring algorithm. The server stores historical records in a performance_data table, including realized duration, realized cost, user satisfaction indicators, and whether a candidate was ultimately executed by the user. The server periodically reads the performance_data table and computes statistical measures such as average deviation between estimated and realized travel times, correlation between cost and user selection, and distribution of user cancellations. The server uses these measures as input to a parameter-updating algorithm that adjusts weighting parameters used in the scoring algorithm. For example, the server may update weights so that features with higher predictive value for realized user satisfaction are given higher influence in future scoring operations. By storing and reusing these parameters in the storage device, the server enables the scoring algorithm to adapt over time, improving selection accuracy and reducing computational waste by suppressing candidates that are consistently inferior.

The server interacts with an external reservation service to perform reservation processing for the selected movement means. The server generates reservation request data including the selected movement candidate identifier, the user's personal and contact information, and payment-related data. The server transmits the reservation request data to an external reservation service through the network. The server receives reservation identification information and reservation detail information from the external reservation service, and stores them in the information storage area as records in a reservations table linked to the movement conditions and movement candidates. The server thereby maintains transactional consistency between requested conditions, selected candidates, and completed reservations.

The server generates notification messages based on the reservation detail information. The server composes message bodies including critical fields such as booking identifiers, departure and arrival times, location identifiers, and total cost. The server submits these messages to an electronic mail transmission service or to a notification distribution service, and records notification status in a notifications table. The terminal receives the notification and displays the message on the display device, thus providing the user with immediate confirmation of the reservation status.

The server further cooperates with a generative artificial intelligence model to generate proposal information related to movement plans. The server maintains a prompt generation module. The server reads structured movement conditions and movement candidate information from the information storage area, and constructs a prompt sentence that encodes these data elements as natural language text. The prompt sentence may include explicit constraints, enumeration of candidates, and desired output formatting. For example, the server may construct a prompt sentence such as:

“Using the following movement conditions: origin=Tokyo, destination=Osaka, date=December 1, desired departure time=09:00, maximum cost=15,000 yen. You have the following transportation options: Option 1: duration=1 hour, cost=10,000 yen; Option 2: duration=2.5 hours, cost=13,000 yen; Option 3: duration=6 hours, cost=9,000 yen.

Generate a recommended travel plan that explains which option should be selected and why, and provide a concise itinerary description suitable for display to the user.”

The server sends the prompt sentence to a generative artificial intelligence model executed on the same server, on another server, or as a cloud-based inference service. The generative artificial intelligence model may be implemented as a neural network with a transformer architecture. The neural network includes an embedding layer that converts tokenized text of the prompt sentence into vector representations, multiple self-attention layers that compute attention scores over token sequences, feed-forward layers that transform hidden states, and an output layer that computes probability distributions over tokens for generating response text. The neural network has been trained in advance by a training system using a corpus of text data and possibly domain-specific travel-planning data. During training, the training system minimizes a loss function such as a cross-entropy error function and updates model parameters using a gradient-based optimization algorithm such as stochastic gradient descent with momentum or an adaptive learning-rate algorithm. The training system may also apply data augmentation methods such as paraphrasing or templated expansion of travel scenarios to improve robustness.

The server receives proposal information from the generative artificial intelligence model as generated text. The server parses the generated text, if necessary, to identify recommended options and explanatory information. The server then converts the proposal information into output data for presentation, for example by mapping referenced options back to internal candidate identifiers and constructing user interface elements such as cards or lists. The server sends the formatted output data to the terminal, which displays the proposal information to the user.

The server integrates the generative artificial intelligence model with the core scoring and selection pipeline in a manner that improves computer technology. The server does not merely delegate subjective explanation to the model; instead, the server uses the model's outputs as structured signals for refining data flows and user interactions. The server, for example, extracts structured recommendations from generated text and stores them as metadata tags associated with movement candidates, thereby enabling subsequent queries and analytics. This approach reduces redundant data transformations and avoids repeated manual creation of explanation templates. By constructing prompt sentences directly from normalized structured data and by storing model outputs in linked tables, the server achieves a tighter coupling between symbolic data and generated text than conventional systems that treat generative models as isolated text generators.

The server uses specific internal data structures and algorithms to obtain technical advantages.

The server represents movement conditions and movement candidate information using normalized relational schemas and feature vectors stored in contiguous memory regions, which reduces cache misses and improves memory access patterns during scoring and evaluation operations. The server executes normalization and scoring algorithms that are deliberately optimized to avoid recomputation of derived features across requests. For example, the server caches normalized location pairs and time windows so that repeated queries for similar routes can reuse intermediate results. This reduces communication load toward external information providing devices and improves overall throughput of the system.

The server applies non-traditional processing sequences that differ from typical rule-based business workflows. The server first constructs a feature space in which both current and historical data are co-located, and then applies similarity evaluation and trend analysis before generating final scores. The server, for example, computes similarity metrics between current feature vectors and historical vectors using an inner-product-based or distance-based formula, and uses these metrics to adjust weighting parameters of the scoring algorithm. This two-phase processing, where historical behavior informs current scoring prior to selection, produces technically measurable effects such as reduced divergence between estimated and realized travel times and reduced frequency of suboptimal reservations, which in turn reduces the need for cancellation processing and repeated queries.

The server can also incorporate the generative artificial intelligence model into this feedback loop. The server may use generated textual rationales to extract additional features, such as identified user preferences or risk assessments, which are then encoded into numerical form and stored in a preferences table. These numerical encodings then become additional dimensions in the feature vectors used by the scoring algorithm. As a result, the server transforms unstructured natural language content into structured computational signals that directly influence algorithmic decisions. This processing is not a mere automation of human judgment, but a machine-oriented transformation that optimizes the internal computational structure of the system.

The system can be deployed in various alternative embodiments. In one embodiment, the server includes multiple processors that distribute tasks for external service access, scoring computations, and generative modeling. In another embodiment, the server offloads the neural network inference to a specialized accelerator such as a graphics processing unit or tensor processing unit, which executes the matrix multiplication operations and activation functions required by the transformer layers. In yet another embodiment, the server employs a smaller, domain-specific generative model co-located with the main application server to reduce network latency and to enable on-premises deployment. In each embodiment, the server manages the data flow between movement conditions, movement candidates, scoring modules, generative model interfaces, reservation services, and notification services in a coordinated pipeline.

The system also supports variations in terminal and user interaction. The terminal may display interactive visualizations of candidate routes and allow the user to adjust preferences, which are then reflected in updated movement conditions and weighting parameters. The server then recomputes scores and may generate updated prompt sentences reflecting these changes. The user may issue natural language instructions at the terminal, and the server may use a natural language understanding module, distinct from the generative model, to convert such instructions into updated structured movement conditions.

By structuring data in normalized relational schemas, by designing specific scoring and normalization algorithms, by using a generative artificial intelligence model with a disclosed architecture and learning protocol, and by integrating historical performance-based parameter updates, the server improves technical aspects of data management, computational efficiency, and external communication. The system reduces redundant external requests through caching and reuse of normalized movement candidate information, reduces computation time by optimizing feature-vector processing, and improves selection accuracy and robustness by adaptively updating scoring parameters based on objective performance metrics. These effects represent improvements in computer technology beyond mere automation of human travel-planning tasks.

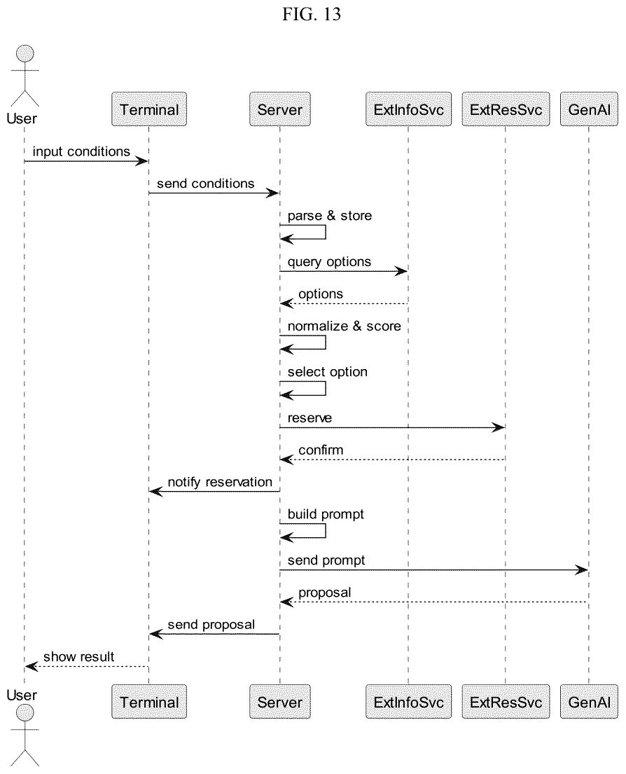

The following describes the processing flow using FIG. 13.

### Step 1:

The user operates the terminal to start a movement-planning session. The user inputs movement conditions, including schedule information, location information, time information, and cost conditions, via an input screen displayed on the terminal. As input, the terminal receives raw user keystrokes and selection events and converts them into structured form fields such as date strings, location strings, time strings, and numeric budget values. As output, the terminal generates a structured request object representing the movement conditions and prepares it for transmission to the server.

### Step 2:

The terminal transmits the structured movement conditions to the server through a communication network. As input, the terminal uses the structured request object created in Step 1 and an address of an application programming interface of the server. The terminal performs data serialization into a message format, attaches user identification and authentication tokens, and sends the message using a network protocol. As output, the terminal generates a network request that is received by the server as an incoming message containing the movement conditions.

### Step 3:

The server receives the incoming message and parses the movement conditions. As input, the server obtains a serialized message that contains schedule information, location information, time information, and cost conditions in a machine-readable format. The server performs message parsing, data type validation, range checking, and format normalization, such as converting date strings into internal date objects and cost strings into numeric values. As output, the server generates a validated and normalized internal representation of the movement conditions.

### Step 4:

The server stores the normalized movement conditions in an information storage area of a storage device. As input, the server uses the internal representation of the movement conditions together with a user identifier. The server executes a data-mapping operation that assigns each movement condition field to corresponding columns of a database table, and then executes a data insertion operation through a database management system. As output, the server obtains a persistent record with a unique movement-request identifier stored in the storage device.

### Step 5:

The server prepares queries for external information providing devices based on the stored movement conditions. As input, the server retrieves the stored movement-request record using the movement-request identifier and extracts schedule, origin, destination, and time constraints. The server transforms location strings into standardized place representations, optionally performing geocoding by converting them into coordinate values. The server then constructs parameter sets for route information providing services and fare information providing services, including origin, destination, and departure time. As output, the server produces one or more query parameter structures ready to be transmitted to external information providing devices.

### Step 6:

The server transmits the query parameter structures to external information providing devices and obtains movement candidate information. As input, the server uses the query parameters generated in Step 5 and endpoints of the external services. The server sends network requests, waits for responses, and handles communication errors or retries if needed. The server then parses the received response messages to extract required time information, fare information, departure times, arrival times, and identifiers of movement means. As output, the server generates a collection of movement candidate records, each representing a possible transportation option.

### Step 7:

The server normalizes the movement candidate information and stores it in the information storage area. As input, the server uses the raw movement candidate records produced in Step 6. The server converts time values to a standard temporal unit, converts cost values to a standard currency and unit, and encodes movement means as categorical codes. The server also associates each candidate record with the corresponding movement-request identifier. As output, the server stores normalized movement candidate records in one or more database tables and produces internal references that link movement conditions to movement candidates.

### Step 8:

The server constructs feature vectors for each movement candidate and computes scores using a scoring algorithm. As input, the server uses normalized attributes of each candidate, including required time, fare, deviation from desired departure time, number of transfers, and any additional quality indicators. The server combines these attributes into numerical feature vectors and applies weighting parameters stored in a configuration table. The server then performs arithmetic operations such as weighted sums or vector multiplications to compute a score for each candidate. As output, the server generates updated candidate records that include computed score values, which are stored or updated in the information storage area.

### Step 9:

The server selects an optimal movement means based on the computed scores and constraint conditions. As input, the server retrieves all candidate records and their scores associated with the movement-request identifier and consults the constraint conditions, such as maximum cost or acceptable time windows. The server filters out candidates that violate constraints and then compares the scores of remaining candidates, applying selection criteria such as minimum score or maximum score depending on the algorithm design. As output, the server identifies one or more optimal movement candidates and designates one candidate as the selected movement means, storing a reference to this selection in the movement-request record.

### Step 10:

The server prepares reservation request data for the selected movement means. As input, the server uses the selected movement candidate attributes, the user's stored profile information, and payment-related information. The server composes a structured reservation request that includes movement identifiers, schedule and location data, and user identifiers, and formats the data according to the protocol expected by an external reservation service. As output, the server produces a reservation request message ready for transmission to the external reservation service.

### Step 11:

The server transmits the reservation request message to an external reservation service and processes the response. As input, the server uses the prepared reservation request message and the service endpoint of the external reservation service. The server sends the message via a network protocol, waits for a response, and handles network-level errors and service-level error codes. When a successful response is received, the server parses reservation identification information and reservation detail information from the response. As output, the server generates structured reservation records that include reservation identifiers, detailed timing, location, seat or class information, and cost confirmation.

### Step 12:

The server stores the reservation records and updates the state of the movement request. As input, the server uses the structured reservation records generated in Step 11 and the corresponding movement-request identifier. The server executes database insertion operations to store the reservation records in a reservations table and performs database update operations to set the status of the movement request to a value indicating successful reservation. As output, the server maintains a transactionally consistent relationship between movement conditions, selected movement candidates, and actual reservations in the storage device.

### Step 13:

The server generates a notification message from the reservation detail information. As input, the server reads reservation records from the reservations table, including reservation identifiers, departure and arrival times, locations, and cost data. The server constructs a human-readable message, formats the content according to the channel (electronic mail or application notification), and includes structured elements such as subject text, body text, and optional metadata. As output, the server produces one or more notification message objects ready to be sent to the user terminal.

### Step 14:

The server sends the notification message to the user terminal via an electronic mail transmission service or a notification distribution service. As input, the server uses the notification message objects from Step 13 and address or token information associated with the user terminal. The server connects to the external mail or notification service, transmits the formatted messages, and receives delivery status responses. The server records the delivery status in a notifications table. As output, the server causes the user terminal to receive a notification containing the reservation detail information.

### Step 15:

The terminal receives the notification and displays the reservation detail information to the user. As input, the terminal obtains a message delivered by an electronic mail service or a notification distribution service, including subject, body, and metadata. The terminal parses the message, stores it in a local message list or mailbox, and renders it on a display device using graphical user interface components. As output, the terminal presents the reservation identifiers, schedule, locations, and cost in a human-readable format, enabling the user to confirm the reservation.

### Step 16:

The server constructs a prompt sentence for a generative AI model based on the stored movement conditions and movement candidate information. As input, the server reads the normalized movement conditions, the list of movement candidates, and their scores from the information storage area. The server converts key data elements into natural language fragments, orders them according to a predefined template, and concatenates them into a single textual prompt sentence. The server may also include explicit instructions on desired output style and constraints. As output, the server produces a textual prompt sentence that describes the movement context and options for input to a generative AI model.

### Step 17:

The server sends the prompt sentence to the generative AI model and obtains proposal information. As input, the server uses the prompt sentence constructed in Step 16 and an interface to the generative AI model. The server tokenizes the prompt text, transmits it to a neural-network-based generative model, and receives generated text as a response. The server then reconstructs full text from the token sequence and, if necessary, parses the generated text to identify recommended options, justification statements, and itinerary descriptions. As output, the server produces structured proposal information that corresponds to recommendations and explanations derived from the model's generated text.

### Step 18:

The server converts the proposal information into output data for presentation on the terminal. As input, the server uses the structured proposal information from Step 17 and the stored movement candidate identifiers. The server maps any candidate references found in the proposal to internal candidate records, assembles human-readable titles, descriptions, and labels, and arranges them into a layout specification suitable for a user interface. As output, the server generates presentation data, such as a structured description of cards, lists, or text blocks, and sends this data to the terminal.

### Step 19:

The terminal receives the presentation data and displays the proposal information to the user. As input, the terminal uses the presentation data transmitted by the server, including recommended options and explanatory texts. The terminal interprets the layout specification, creates on-screen elements such as panels, buttons, and text fields, and populates them with the received content. As output, the terminal renders a visual interface that allows the user to review proposed movement plans, understand reasons for the recommendations, and, if desired, confirm or modify the plan.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional travel-planning and lifestyle-support systems generally rely on fixed rule sets or static recommendation engines that separately handle user inputs, external reservation services, and user interface rendering. In such systems, several technical problems arise.

First, existing systems often treat natural-language user input as opaque text, performing only shallow keyword matching without robust conversion into normalized, machine-usable structures. As a result, the backend must maintain complex, hand-crafted rules to infer dates, times, locations, and prices, leading to brittle behavior, high maintenance costs, and inconsistent responses when the input deviates from expected formats. This limits the ability of the system to scale to diverse user expressions and languages.

Second, typical architectures do not integrate generative AI models, external routing and booking services, and centralized reservation management into a coherent control flow. Instead, each function-route search, hotel search, food ordering, and display formatting—is wired in an ad hoc manner, so that changes in one component (for example, a booking API or a UI format) require manual reconfiguration of multiple layers. This causes increased latency, error-prone data transformations, and difficulty in guaranteeing end-to-end consistency of booking data across heterogeneous external services.

Third, conventional systems handle user “preference” and “emotion” as static attributes, if at all, and do not technically integrate real-time emotion estimation into the decision-making pipeline. Emotion signals, when present, are usually used as cosmetic filters rather than as first-class parameters in the backend computation. Accordingly, existing systems cannot dynamically adjust prompt sentences for a generative AI model or selection criteria for transportation, accommodation, and meal options based on the user's current state. This results in recommendations that are not contextually adaptive and increases the need for manual user corrections, which in turn increases server-client traffic and interface complexity. Fourth, known systems typically lack a unified reservation-management mechanism that normalizes confirmation information from heterogeneous external reservation devices and services. Since each external provider returns confirmations in its own format, application logic must repeatedly implement custom parsing and storage routines. This redundancy leads to increased processing overhead on the server, higher memory usage due to duplicated data structures, and a higher failure rate when external formats change.

Fifth, there is no standardized, machine-enforced pattern for constructing, executing, and interpreting “prompt sentences” that drive a generative AI model in coordination with structured data, external APIs, and UI feedback. As a result, when a generative model is introduced, the “glue logic” between the model output and deterministic routing/booking logic tends to be ad hoc. This degrades system reliability, makes error handling difficult, and prevents re-use of a common “prompt+validation+selection” pipeline across different domains such as travel, lodging, and food ordering.

Accordingly, there is a need for an improved computer-implemented system and server-side control logic that: (i) systematically converts heterogeneous natural-language inputs into structured representations; (ii) generates and executes prompt sentences for a generative AI model in a repeatable and verifiable manner; (iii) merges AI-generated candidate plans with real-time data from external routing and booking services; (iv) centrally manages all reservation confirmation information; and (v) adaptively changes both prompt sentences and selection criteria based on real-time emotion estimation. Such a system should technically improve processing robustness, reduce redundant business logic, maintain consistency of reservation data across interfaces, and enable more efficient, lower-latency interaction between the user terminal and the backend processor.

The specific processing by the specific processing unit 290 of the data processing device 12 in Application Example 2 is realized by the following means.

The present invention provides a server comprising a processor configured to receive, from a user terminal, input information including funding conditions, schedule conditions, and preference conditions via an input/output interface; to analyze natural-language expressions included in the input information by language processing so as to convert the input information into structured information including date information, time information, location information, and price information; to estimate an emotion state of the user by analyzing user-provided text, voice, or image information; to generate, on the basis of the structured information and the emotion state, a prompt sentence that instructs a generative information processing model to generate a travel plan or a lifestyle plan; to input the prompt sentence into the generative information processing model and acquire candidate information including transportation means, accommodation means, and meal means; to collate the candidate information with route information, fee information, and availability information obtained from external information processing services and thereby select concrete transportation means, accommodation means, and meal means; to execute, via interfaces to external reservation information processing apparatuses, reservation processing or order processing for the selected means and automatically acquire and persistently store corresponding confirmation information in a unified reservation management data structure; and to format and transmit, to the user terminal, visual display information including the confirmation information and the generated plan in a time-ordered or category-ordered layout while, in response to user approval or change instructions, dynamically regenerating the prompt sentence and re-executing plan selection based on updated structured information and emotion state. This enables a technically integrated “prompt sentence plus generative AI model” pipeline in which the server systematically converts free-form user input into normalized data, invokes the generative model in a controlled manner, reconciles model output with real-time external services, adaptively tunes recommendation criteria according to the user's emotion, and centrally manages heterogeneous confirmation information, thereby improving robustness, scalability, and efficiency of the computer-implemented travel and lifestyle planning system.

The term “user terminal” refers to an information processing apparatus operated by a user, such as a computing device equipped with an input/output interface, that transmits input information to the server and receives display information from the server.

The term “input information” refers to data provided from the user terminal to the server, including at least funding conditions, schedule conditions, preference conditions, and optionally text, voice, or image information that expresses intentions or emotions of the user.

The term “funding conditions” refers to information indicating monetary constraints or budget ranges specified by the user for transportation means, accommodation means, meal means, or other services related to a plan.

The term “schedule conditions” refers to information indicating temporal constraints specified by the user, including dates, times, and durations associated with travel, stay, or other activities.

The term “preference conditions” refers to information indicating qualitative or quantitative user preferences, including desired destinations, facility types, transportation characteristics, meal types, or service attributes to be considered when generating a plan.

The term “information input/output interface” refers to a hardware and/or software component of the server or the user terminal that manages communication of data, including sending requests and receiving responses, between the user terminal and the server over a communication network.

The term “natural language expressions” refers to text or speech content produced in a human language by the user, which may include free-form sentences, phrases, or utterances describing requirements, preferences, or emotional states.

The term “language processing” refers to computational processing that analyzes natural language expressions, including at least tokenization, parsing, entity recognition, and normalization, to extract structured data such as dates, locations, times, and monetary amounts.

The term “structured information” refers to information represented in a machine-readable format with defined fields, including at least date information, time information, location information, and price information, which can be directly used by planning and reservation logic in the server.

The term “date information” refers to structured data representing calendar dates associated with planned travel, stay, or activities, expressed in an absolute or normalized calendar format.

The term “time information” refers to structured data representing clock times or time ranges associated with departures, arrivals, check-in, check-out, or activity start and end times.

The term “location information” refers to structured data representing places relevant to a plan, including origins, destinations, accommodation locations, facility locations, or geographic regions, expressed for example as place names, coordinates, or standardized location identifiers.

The term “price information” refers to structured data representing cost values, such as fares, room rates, or meal prices, associated with transportation means, accommodation means, or meal means.

The term “emotion information” refers to data representing an emotional condition of the user, obtained by analyzing text, voice, or image information, and including emotion categories, scores, or tags used by the server to adapt plan generation.

The term “emotion state” refers to a classification of the user's psychological condition, such as stress, fatigue, excitement, or relaxation, derived from emotion information and used as a parameter in plan generation and selection.

The term “prompt sentence” refers to a machine-generated, human-readable instruction string provided by the server to a generative information processing model, the instruction string specifying at least input context, constraints, and an expected output format for plan generation.

The term “generative information processing model” refers to a computational model, such as an artificial intelligence model trained on large-scale data, that generates output information including candidate plans or options in response to a prompt sentence.

The term “candidate information” refers to intermediate output data produced by the generative information processing model, including a plurality of potential transportation means, accommodation means, meal means, or activities that may satisfy user conditions.

The term “transportation means” refers to a type of transport service or vehicle arrangement used for moving the user between locations, including, for example, public transport, private vehicles, shared vehicles, or automated vehicles.

The term “accommodation means” refers to a type of lodging service or facility arrangement used for the user's stay, including, for example, hotels, inns, rental properties, or other overnight facilities.

The term “meal means” refers to a type of food-related service or facility arrangement used for providing meals to the user, including, for example, restaurants, delivery services, or prepared meal offerings.

The term “route information” refers to data indicating one or more paths between an origin and a destination, including intermediate waypoints, expected travel times, distances, and routing options.

The term “fee information” refers to data indicating costs associated with transportation means, accommodation means, meal means, or other services, typically expressed as monetary values per segment, per night, per item, or per plan.

The term “availability information” refers to data indicating whether particular transportation means, accommodation means, or meal means can be reserved or ordered at specified times, including capacity, inventory, and scheduling constraints.

The term “external information processing service” refers to a remotely located computing service accessible over a network, which provides at least one of route information, fee information, availability information, or reservation processing for transportation, accommodation, or meals.

The term “concrete transportation means, accommodation means, and meal means” refers to specific, selectable service instances or options, determined after evaluating candidate information against real-time external data, that can actually be reserved or ordered for the user.

The term “external reservation information processing apparatus” refers to an information processing system provided by a service provider, such as a transport operator, lodging provider, or food service provider, that performs reservation or order processing in response to structured requests.

The term “reservation processing” refers to processing that allocates and confirms the right for the user to use a transportation means, accommodation means, or service at a specified time, including generation of a confirmation identifier.

The term “order processing” refers to processing that places and confirms a request for provision of goods or services, such as meals or ancillary services, including generation of an order identifier.

The term “confirmation information” refers to data returned from an external reservation information processing apparatus as a result of reservation processing or order processing, including at least identifiers, schedule details, and essential terms of the reserved or ordered services.

The term “reservation management processing” refers to processing that stores, normalizes, and collectively manages confirmation information from heterogeneous external systems within a unified data structure on the server.

The term “visual display information” refers to data structures prepared for presentation on a display device of the user terminal, including formatted text, icons, and layout information that represent plans, reservations, and options in human-readable form.

The term “display control processing” refers to processing that generates visual display information from internal plan and reservation data, transmits the visual display information to the user terminal, and handles user interactions such as approval instructions or change instructions.

The term “approval instruction” refers to a user operation indicating acceptance of a proposed plan or reservation, transmitted from the user terminal to the server.

The term “change instruction” refers to a user operation indicating a request to modify at least part of a plan or reservation, transmitted from the user terminal to the server.

The term “emotion adaptation processing” refers to processing that modifies at least one of the contents of a prompt sentence and the selection conditions for transportation means, accommodation means, and meal means, based on the estimated emotion state of the user.

The term “storage device” refers to a non-transitory computer-readable medium, such as a disk device or semiconductor memory, that stores plan information, reservation information, user preference information, or model parameters.

The term “past plan information” refers to stored data describing travel plans, lifestyle plans, or other historical plans previously generated, confirmed, or used by the user or by multiple users.

The term “past reservation information” refers to stored confirmation information and associated details from previous reservations or orders for transportation, accommodation, meals, or other services.

The term “preference information” refers to data derived from analysis of past plan information and past reservation information, representing tendencies or patterns in user choices that can be used to personalize future plan generation.

The term “inference processing unit” refers to a hardware and/or software component, separate from or integrated with the generative information processing model, that performs reasoning, scoring, or selection based on structured information, emotion information, and preference information.

The term “comprehensive plan information” refers to plan data in which transportation means, accommodation means, and meal means are combined with region-related information such as tourism information, event information, or facility information, to provide an integrated user experience.

The term “region-related information” refers to information associated with a geographical area relevant to a plan, including tourism information, event information, facility information, or meal information specific to the area.

In one embodiment, a server implements the claimed system as a network-connected computing device comprising at least one central processing unit (CPU), at least one graphics processing unit (GPU) or tensor processing unit (TPU), a main memory, a non-transitory storage device, and a network interface. The server executes software modules including an HTTP server module (for example, implemented using a web application framework), a natural language processing module (for example, implemented using a language processing library), a generative AI interface module, an emotion estimation module, a planning and selection module, a reservation management module, and a display formatting module. The server stores user-related data, plan data, and reservation data in a relational database management system, such as a structured-query-based database, and optionally stores preference profiles or logs in a document-oriented database.

In one embodiment, a terminal implements the user terminal as a mobile computing device such as a smartphone, a tablet, or smart glasses, or as a personal computer executing a web browser. The terminal comprises a display, a touch panel or pointing device, a microphone, a camera, a local storage area (for example, an embedded key-value store or a local relational database), and a communication module. The terminal executes a client application or browser-based script that provides graphical input forms, captures text, voice, or image information from a user, and communicates with the server via a secure communication protocol.

In one embodiment, a user operates the terminal to input funding conditions, schedule conditions, and preference conditions, as well as optional free-form text describing emotional state. The user enters, for example, a sentence such as “I want to go from the central station to the airport tomorrow at 10 a.m., and I would like to stay near the airport tonight within a budget of 150 units per night,” or “I feel very tired and want a relaxing weekend trip next month with a total budget of 1000 units.” The terminal converts spoken input to text using a speech-to-text component, and optionally down-samples or compresses image or audio streams for emotion analysis. The terminal encapsulates the input information into a structured message and transmits the message to the server.

In one embodiment, the server uses a natural language processing module implemented with a language processing library (for example, a pipeline including tokenization, part-of-speech tagging, dependency parsing, and named entity recognition) to convert the received natural language expressions into structured information. The server identifies calendar expressions, time-of-day expressions, location names, and monetary amounts. The server normalizes relative time expressions (for example, “tomorrow,” “next weekend”) into absolute timestamps using a date normalization function that maps relative offsets to calendar dates based on the current date and local time zone. The server assigns the parsed elements into a query data structure including fields such as origin_location_id, destination location_id, departure_timestamp, return_timestamp, max_budget, and other preference flags.

In one embodiment, the server implements emotion estimation as a combination of rule-based and model-based processing. The server extracts features from text, such as the presence of lexical cues (“tired,” “stressed,” “relaxed,” “excited”), syntactic patterns, and sentiment polarity scores. The server additionally extracts acoustic features from audio, such as pitch, intensity, and spectral characteristics, and extracts visual features from images, such as facial landmarks and expression-related parameters. The server uses a trained neural network, for example a multi-layer architecture including one or more convolutional layers for image features, one or more recurrent or transformer layers for text sequences, and fully connected layers for joint fusion, to output a probability distribution over a predefined set of emotion categories. The server uses a loss function such as categorical cross entropy during training of this network on annotated multimodal emotion datasets and updates weights using gradient descent with an optimizer such as Adam. In operation, the server thresholds the output probabilities and assigns an emotion tag such as “stressed,” “tired,” or “excited” to the current user session.

In one embodiment, the server generates a prompt sentence for a generative AI model based on both the structured information and the emotion state. The server constructs the prompt sentence using a template mechanism that inserts normalized fields into natural-language instruction patterns. The server ensures that each prompt sentence contains explicit constraints (for example, budget ranges, time windows, and region constraints), a description of the emotion state, and a required output format. Example prompt sentences include:

“The user wants to travel from the central station to the airport tomorrow, departing around 10:00 a.m. The total travel budget is 50 units. The user prefers an autonomous vehicle if possible and wants to minimize transfers. Propose the optimal transportation option and briefly justify your choice. Output: transport_mode, estimated_travel_time_minutes, and reason.”

“The user wants to stay in the metropolitan area from 2023 Dec. 1 for 3 nights with a budget of 100 units per night. The user prefers a quiet area near a public transport station. Propose 3 suitable lodgings within this budget. Output as a list with elements: lodging_name, area, approximate_price_per_night, and reason.”

“The user is planning a 3-day trip next month with a total budget of 1000 units and is currently feeling stressed and tired. Propose a travel plan that focuses on relaxation, including a destination, suggested lodging type, and 2 to 3 daily activities, while minimizing the number of transfers. Provide the plan in structured bullet points.”

“The user feels tired today and wants a simple and comforting dinner. The user likes local cuisine and cannot eat shellfish. From the following list of menu items, select a suitable combination. Output: main_dish, side_dish, drink, and reason.”

In one embodiment, the server transmits the prompt sentence to a generative AI model hosted on the server or on a separate computing resource. The generative AI model may be implemented as a large-scale neural network such as a transformer-based language model. The model comprises an embedding layer that maps tokens to vector representations, a plurality of self-attention blocks that process sequences with multi-head attention and feed-forward sublayers, and an output layer that predicts token distributions. The model is trained on large corpora of text data using an unsupervised objective such as next-token prediction, and may be fine-tuned on domain-specific corpora containing travel, lodging, and lifestyle-planning texts. During training, the server or another training system uses a loss function such as cross entropy between predicted tokens and ground-truth tokens, and updates model parameters via backpropagation.

In one embodiment, the server uses a generative AI interface module to issue inference requests to the generative AI model. The server encodes the prompt sentence into tokens, passes them through the model, and obtains output token sequences. The server decodes the token sequences into text and further interprets the text using a deterministic parser. For example, the server expects the model to output specific field labels or delimiters and uses pattern matching or a secondary minimal grammar to extract candidate transportation segments, lodging options, and meal options. The server discards outputs that conflict with the explicit constraints or that do not satisfy basic syntactic checks.

In one embodiment, the server merges the AI-generated candidate information with real-time data from external information processing services. For transportation means, the server queries a routing service over a network using an origin, a destination, and a departure timestamp. The routing service returns multiple route options with attributes such as travel time, distance, fare, and transfer count. The server associates each AI-suggested mode or route with those concrete options, and computes a score that is a weighted function of normalized travel time, cost, transfer count, and an emotion-dependent penalty. For example, when the emotion state indicates fatigue, the server increases the weight assigned to transfer count and decreases tolerance for long travel times. The server selects a subset of transportation options that maximizes the score under the budget constraint.

In one embodiment, the server contacts lodging reservation services using an application programming interface. The server builds query parameters from the structured information (check-in and check-out dates, maximum nightly price, region) and AI-suggested lodging characteristics (for example, “near station,” “quiet area,” or “hot spring resort”). The lodging service returns available rooms with prices and attributes. The server performs fuzzy matching between model-generated lodging names or descriptions and actual lodging entries, using string similarity metrics and location proximity. The server ranks candidate lodgings based on a composite scoring function that incorporates price, distance to key points, and user preference vectors derived from historical reservations.

In one embodiment, the server manages meal selection and ordering similarly. The server uses the structured location information and time constraints to determine an ordering radius and time window. The server queries a food-ordering service for available restaurants and menu items. The server maps AI-suggested dishes to concrete menu items, considering dietary constraints stored in a user profile. The server then uses an optimization routine to pick a set of items that satisfies nutritional, budgetary, and emotion-driven constraints (for example, avoiding heavy meals when the user reports stress).

In one embodiment, the server executes reservation processing by interacting with external reservation information processing apparatuses. The server sends structured reservation messages that contain user identifiers, selected transportation or lodging identifiers, times, and payment tokens. The external systems respond with confirmation identifiers, fare or rate breakdowns, and cancellation conditions. The server normalizes these heterogeneous confirmation formats into a unified reservation record structure with fields such as provider_type, provider_id, confirmation_code, start_time, end_time, total price, and status.

The server stores the normalized records in the database and maintains referential links from each record to the associated user and trip identifier.

In one embodiment, the server implements reservation management processing as a dedicated module that enforces consistency and atomicity across multiple external reservations. The server uses transaction mechanisms within the database to group related reservation records. If any required reservation fails, the server can execute programmed rollback operations, such as automatically sending cancellation messages for already-confirmed reservations. This transactional support reduces inconsistent states and decreases the need for manual error correction.

In one embodiment, the server formats travel and lifestyle plans for presentation by arranging reservations and suggested activities into a timeline or category-based layout. The server builds a plan data structure that organizes events chronologically, annotated with human-readable descriptions, map links, and emotion-based labels. The display formatting module converts this structure into a platform-neutral representation (for example, a hierarchical object) containing strings, icons, and layout hints. The server transmits the representation to the terminal, which renders the plan in its native toolkit. The server also includes explanatory strings derived from the generative AI output to indicate why certain choices were made, such as “This route was selected to minimize transfers because you indicated that you are tired.”

In one embodiment, the terminal displays the plan on its display and provides interactive elements for approval or change instructions. The user may tap a control labeled “Confirm all,” or select a specific segment such as “Change hotel” or “Depart later.” The terminal sends updated constraints or explicit selection instructions back to the server. The server then updates the structured information and, if appropriate, regenerates a prompt sentence and repeats the selection and reservation process.

In one embodiment, the server implements emotion adaptation processing as a feedback loop.

The server stores a history of emotion states and user interactions for each trip. When a new emotion state is received, the server compares it with recent states, detects significant changes, and recalculates an emotion-weight vector used in scoring and constraint generation.

The server also selects different prompt templates depending on emotion state; for example, when the user is excited, the server uses templates that request “novel and adventurous activities,” whereas when the user is stressed, the server uses templates that request “quiet, relaxing experiences with minimal movement.” This explicit mapping from emotion categories to prompt templates and scoring weight vectors constitutes a non-conventional control mechanism that operates at the level of server algorithms and internal data structures, rather than merely re-labeling output for display.

In one embodiment, the server uses preference extraction to further refine recommendations.

The server periodically trains or updates a user-preference model that maps user identities and item features to preference scores. The item features include numerical descriptors derived from structured information (for example, distance to city center, price deviation from average, star rating) and categorical descriptors (for example, lodging category, transportation mode). The preference model may be implemented as a matrix-factorization model, a gradient-boosted decision tree model, or a neural network with embedding layers for users and items. The model is trained with historical reservation data, using a loss function such as mean squared error or pairwise ranking loss, and updated incrementally as new reservation records are stored. During plan generation, the server uses this model to score candidate options together with emotion-adjusted scoring functions.

In one embodiment, these technical arrangements improve computer technology in multiple ways. Because the server converts free-form input into structured information with explicit normalization and uses generated prompt sentences that encode constraints and output formats, the server can reuse a single generative AI call pattern across different domains while ensuring that only consistent and parsable outputs are accepted. This reduces the amount of domain-specific, hand-coded logic required in the backend, which in turn decreases maintenance complexity and reduces the likelihood of runtime errors when external APIs change. The use of unified reservation structures and transactional reservation management reduces duplicated data and supports more efficient querying, leading to lower memory use and faster response times when retrieving or modifying a plan.

In another embodiment, the server improves computational efficiency by decomposing the generative process into a constrained generation step followed by deterministic validation and optimization. By offloading the high-level combinatorial exploration of possibilities to the generative AI model and then applying deterministic, algorithmic scoring and constraint checking, the server reduces the search space that must be handled purely by traditional algorithms, thereby achieving better scalability as the number of available services increases.

In another embodiment, the emotion-aware adaptation of prompt sentences and scoring weights materially changes internal computation within the server. Instead of treating emotion as a simple filter, the server uses emotion as an input to generate different prompt sentences and to alter weight vectors in multi-objective optimization. This leads to different ranking results than would be obtained by rule-based filtering alone and reduces oscillations between user corrections and server proposals, which lowers the total number of server-client round trips and decreases network load.

In another embodiment, the system may be implemented in alternative configurations. The generative AI model may be deployed as a cloud service separate from the main server, and the server may maintain a local caching mechanism for prompt sentences and model outputs to reduce latency. The emotion estimation may be partially executed on the terminal, with only anonymized emotion tags transmitted to the server. The database system may be replaced by another storage technology as long as it supports the unified reservation record structure. The planning and selection module may use different optimization techniques, for example linear programming or heuristic search, instead of weighted scoring, while still using the same structured candidate representation produced from generative AI outputs and external service data.

In another embodiment, the server may be extended to control physical devices. For example, when the selected transportation means includes an automated vehicle, the server may transmit route and timing parameters to a vehicle control platform, which distributes low-level control commands to the vehicle. In such a case, the server's route selection and scheduling algorithms directly influence sensor and actuator control in the physical world, demonstrating that the invention is not limited to abstract information display but provides concrete control of machines.

In summary, the server, the terminal, and the user interact through a set of specifically defined data structures, prompt sentence templates, neural network models, and decision algorithms that together implement the claimed system. The server uses natural language processing, trained neural networks, generative AI models, structured reservation management, and emotion-adaptive optimization in a coordinated manner that improves the robustness, efficiency, and technical capabilities of travel and lifestyle planning beyond mere automation of human mental steps.

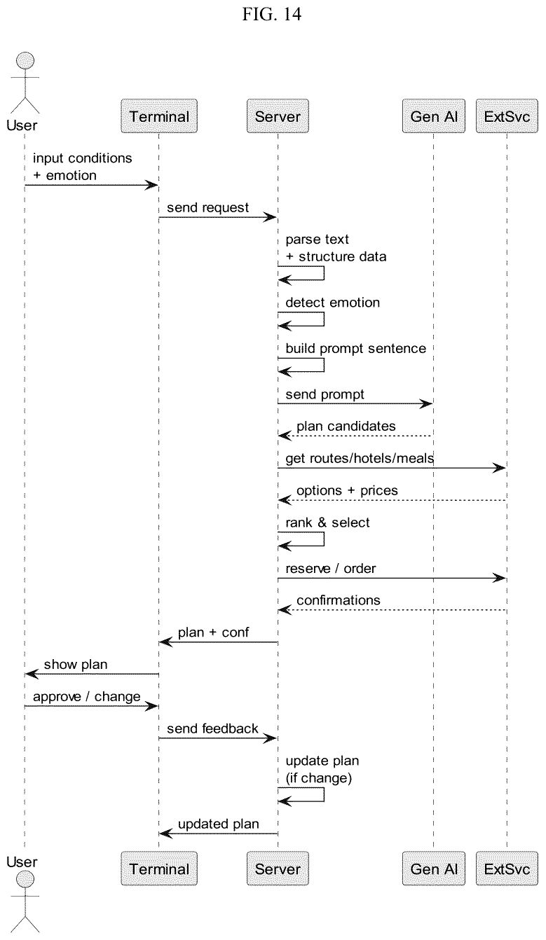

The following describes the processing flow using FIG. 14.

### Step 1:

User operates the terminal to input conditions and emotional context.

User enters funding conditions, schedule conditions, and preference conditions into input fields of an application or web page on the terminal, and optionally adds free-form text such as “I am very tired and want a relaxing trip,” or provides voice or image data via the microphone and camera. The input of this step is raw user data (text strings, selected options, voice/audio samples, and image frames). The output of this step is a structured message on the terminal containing the raw user data and associated metadata (user identifier, timestamps, language, and device information).

### Step 2:

Terminal structures and transmits the user input to the server.

Terminal converts spoken utterances to text using a speech-to-text component, compresses or down-samples audio or image data if present, and maps form fields into typed variables such as budget, date strings, and locations. The input of this step is the raw user data prepared in Step 1. The terminal performs data formatting and basic validation (for example, checking that date fields are not empty) and then encapsulates everything into a machine-readable message, such as a JSON object with keys for text_input, budget_value, date_strings, preference_flags, and media_references. The output of this step is a validated and serialized message transmitted over a secure communication channel from the terminal to the server.

### Step 3:

Server receives and validates the structured message.

Server accepts the incoming request via its network interface and deserializes the message into in-memory objects. The input of this step is the serialized message from the terminal. The server checks that mandatory fields (such as at least one date, a budget value, and a primary location) are present and within acceptable ranges. The server logs the raw payload into a storage device for traceability and assigns a session or trip identifier to group related operations. The output of this step is a validated internal representation of the user request, linked to a unique trip identifier in the server's memory and database.

### Step 4:

Server converts natural language into structured information.

Server applies a natural language processing module to the text portion of the user input. The input of this step is the free-form text and any label-like fields (for example, “from station A to station B tomorrow at 10 a.m.”). The server tokenizes the text, performs part-of-speech tagging, and uses named entity recognition to detect dates, times, locations, and monetary amounts. The server uses a date-normalization routine to convert relative temporal expressions (such as “tomorrow” or “next weekend”) into absolute timestamps based on the current system time and locale. The server then stores these normalized values in a structured data object with fields such as origin_location_id, destination_location_id, departure_timestamp, return_timestamp, and budget_amount. The output of this step is a set of structured information records, written to the database and available to subsequent modules.

### Step 5:

Server estimates the user's emotion state.

Server analyzes emotion-related inputs using a combination of rules and a trained neural network model. The input of this step is the emotion-relevant data: emotion-related words in the text, extracted acoustic features from audio, and visual features from images when available. The server applies text-based sentiment and emotion classifiers to compute scores for categories such as “stress,” “fatigue,” and “excitement.” The server passes extracted features into a trained neural network, for example a model with convolutional layers for images, recurrent or transformer layers for text, and fully connected fusion layers, and obtains a probability distribution over emotion categories. The server then applies thresholding and selects the most likely emotion state, such as “tired” or “excited.” The output of this step is an emotion tag and associated scores stored in an emotion_state object linked to the trip identifier.

### Step 6:

Server constructs a prompt sentence for the generative AI model.

Server combines the structured information and the emotion state in a template-driven process to construct a prompt sentence. The input of this step is the normalized travel or lifestyle conditions (dates, locations, budgets, preferences) and the emotion_state object. The server selects a template based on the type of planning (for example, transportation-focused, lodging-focused, or meal-focused) and the emotion category. The server fills template slots with normalized field values and adds explicit constraints and desired output format descriptions. For example, the server may generate:

“The user wants to travel from the central station to the airport tomorrow, departing around 10:00 a.m. The total travel budget is 50 units. The user prefers an autonomous vehicle if possible and wants to minimize transfers. Propose the optimal transportation option and briefly justify your choice. Output: transport_mode, estimated_travel_time_minutes, and reason.”

The output of this step is a prompt sentence string, ready for submission to the generative AI model.

### Step 7:

Server calls the generative AI model and interprets its output.

Server sends the prompt sentence to a generative AI model via a model interface. The input of this step is the prompt sentence created in Step 6. The server encodes the sentence into tokens, passes the tokens to a transformer-based language model configured with specific inference parameters (for example, maximum token count and sampling temperature), and receives generated tokens as output. The server decodes these tokens back into text and then applies deterministic parsing logic, such as pattern matching or minimal grammars, to extract candidate entries for transportation means, accommodation means, or meal means. The server drops or flags outputs that do not comply with the specified output structure or violate hard constraints (for example, exceeding budget). The output of this step is a set of AI-generated candidate options represented in an internal candidate list structure.

### Step 8:

Server augments candidate options with real-time external data.

Server queries external information processing services to obtain actual route, availability, and price information. The input of this step is the AI-generated candidate list combined with the structured information (locations, times, budget). For transportation, the server sends origin, destination, and desired departure time to a routing service and obtains possible routes with travel times, distances, and fares. For lodging, the server queries a lodging service with dates, area, and price range to get available rooms, and for meals, the server queries a food-ordering service for restaurants and menus near the user's location. The server then aligns candidate items with external results by matching names, categories, and locations, and creates augmented candidate records that include both AI-proposed attributes and concrete real-time data. The output of this step is a set of augmented candidate records for each category (transportation, lodging, meals), each containing identifiers, prices, durations, and constraint-relevant attributes.

### Step 9:

Server ranks and selects concrete transportation, accommodation, and meal options. Server applies a scoring and optimization algorithm to the augmented candidate records. The input of this step is the augmented candidate sets and the emotion_state object, plus any historical preference weights stored in a user-profile model. The server computes a score for each candidate using a function that can incorporate travel time, price, number of transfers, distance to key locations, preference match, and emotion-dependent penalties or bonuses. For example, when the emotion state is “tired,” the server increases penalties for long travel times and many transfers. The server then sorts candidates by score and selects one or more top-ranked options in each category that satisfy budget and time constraints. The output of this step is a selection of concrete transportation means, accommodation means, and meal means represented as fully specified service options.

### Step 10:

Server performs reservation and order processing with external systems.

Server sends reservation and order requests for the selected concrete options to external reservation information processing apparatuses. The input of this step is the selected options with all necessary parameters (service identifiers, schedule times, user identifiers, and payment tokens). The server formats each request according to the external system's interface specification, transmits the requests, and receives confirmation responses including confirmation codes, final prices, and terms. The server normalizes these heterogeneous confirmations into unified reservation records and stores them in the reservation management database. The output of this step is a set of confirmation records linked to the trip identifier, each record containing normalized fields such as provider_type, confirmation_code, start_time, end_time, and total_price.

### Step 11:

Server generates plan and display information for the terminal.

Server constructs a comprehensive plan structure from the selected options and the reservation records. The input of this step is the normalized reservation records, the remaining candidate suggestions (if any), and explanation text from the generative AI model. The server arranges events chronologically, groups them by category (transport, lodging, meals, activities), and attaches descriptive strings and visual metadata (for example, icons and map coordinates). The server formats this into a display-ready structure that can be rendered as timelines, lists, or maps on the terminal. The output of this step is display information that encodes the complete plan and explanations, sent from the server to the terminal.

### Step 12:

Terminal presents the plan and captures user feedback.

Terminal receives the display information and renders it using its graphical user interface components. The input of this step is the plan data structure generated in Step 11. The terminal displays routes, hotel details, meal orders, times, and reasons such as “chosen to minimize transfers because you are tired.” The user can scroll, expand items for details, and use controls to approve or modify the plan, for example, by tapping “Confirm all,” “Change this lodging,” or “Depart later.” The output of this step is user feedback in the form of approval instructions or change instructions, which the terminal packages into a structured message and sends back to the server.

### Step 13:

Server processes approval or change instructions and, if necessary, regenerates plans. Server receives the user's feedback and updates internal state accordingly. The input of this step is the structured approval or change instructions from the terminal. If the user approves, the server marks the trip as confirmed and may adjust notification schedules. If the user requests changes, the server updates the structured information (for example, changing a departure time or narrowing a price range) and optionally reevaluates emotion state based on new text input. The server then generates a new or modified prompt sentence incorporating the updated constraints, sends it again to the generative AI model, re-augments and re-ranks candidates, and performs new reservations or cancellations as needed. The output of this step is an updated set of reservation records and plan information, which the server again transmits to the terminal for display.

### Step 14:

Server and terminal handle ongoing emotion-based adjustments during execution of the plan. User may, during or before execution of the plan, provide updated emotional feedback through the terminal. The input of this step is new emotion-related data (for example, “I feel sad now” or a facial expression captured by the camera). The terminal transmits this data to the server, which updates the emotion_state object and recomputes emotion-dependent scoring weights and prompt templates. The server constructs new prompt sentences such as “The user is currently on day 2 of a 3-day trip and now feels sad. Suggest 2 or 3 nearby comforting activities this afternoon that require minimal travel,” and repeats the generative AI, augmentation, and selection sequence for optional activities. The output of this step is adjusted or additional plan components aligned with the new emotion state, delivered to the terminal as updated display information for user approval.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

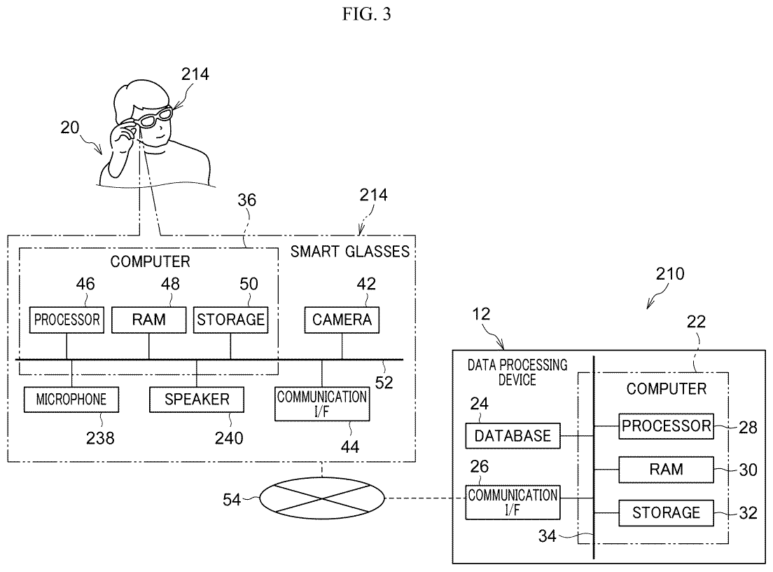

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52.

The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

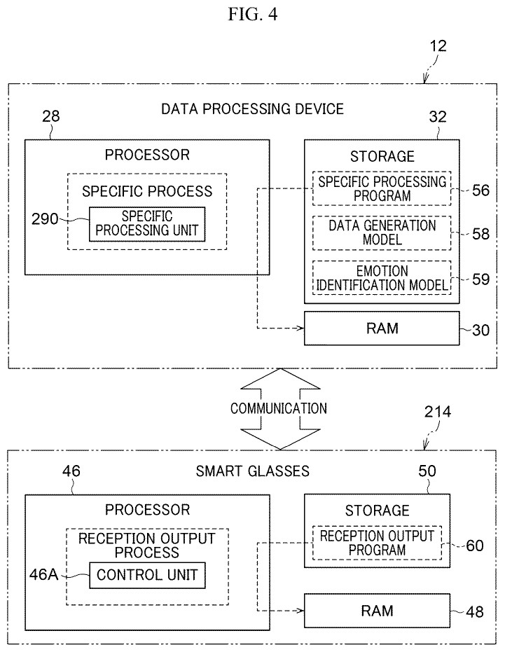

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

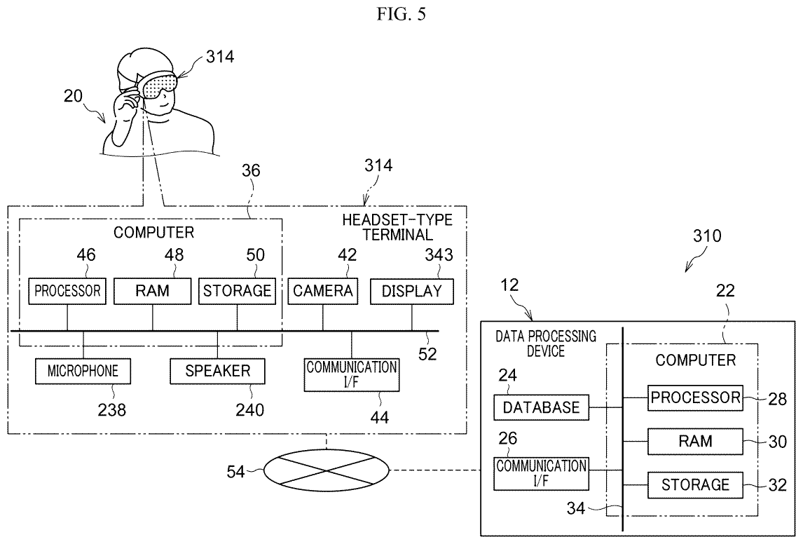

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

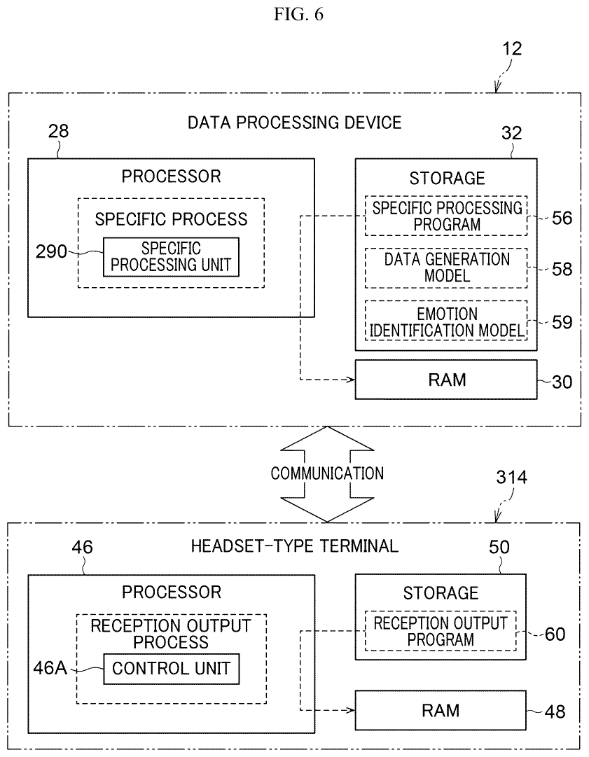

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12.

For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

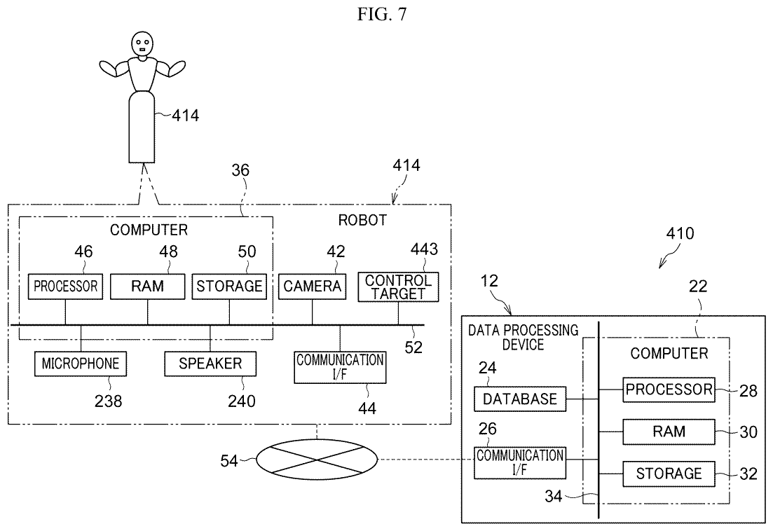

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

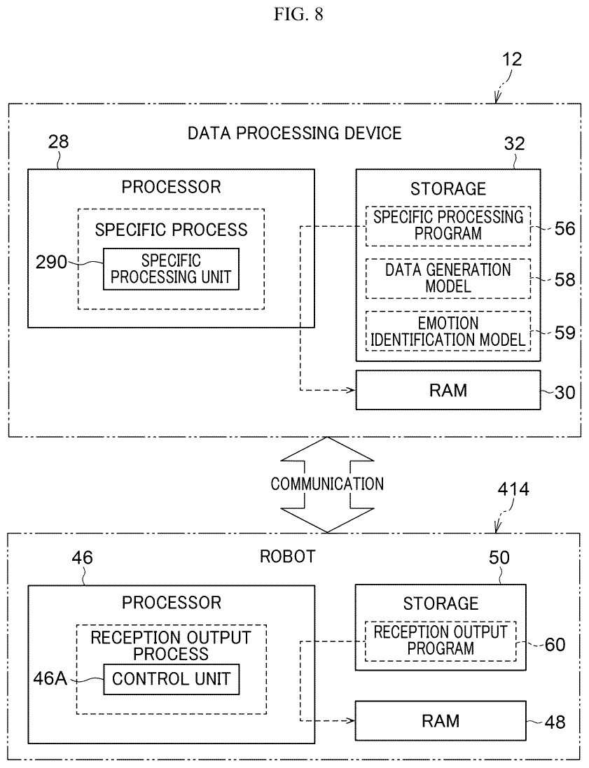

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

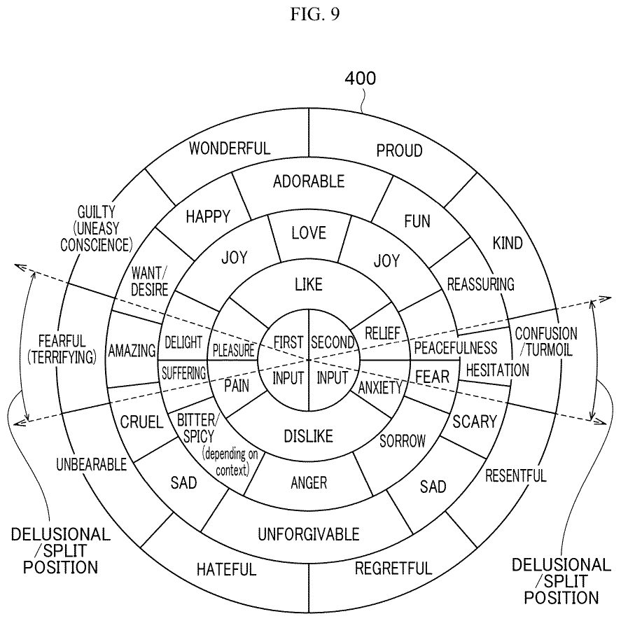

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

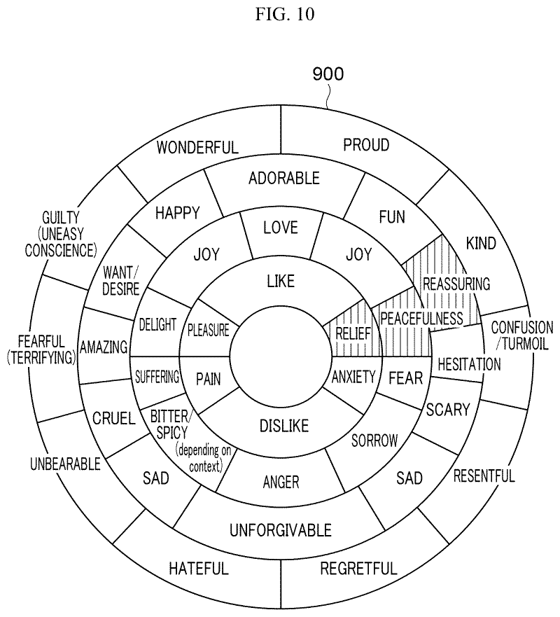

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC).

Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
present, to a communication terminal, an operation screen for acquiring a cost condition, a time condition, and a preference condition from a user,
receive, from the communication terminal, structured information including the cost condition, the time condition, and the preference condition, and perform format checking, value checking, and normalization processing on the structured information,
aggregate the normalized structured information as internal condition information, and, based on the internal condition information, generate a prompt sentence to be input to a generative information processing apparatus by executing template-based document generation processing or character-string concatenation processing,
transmit, via a communication interface toward the generative information processing apparatus, request information including the prompt sentence, and acquire itinerary information generated by the generative information processing apparatus in response to the prompt sentence,
analyze the itinerary information, convert the itinerary information into hierarchical structure data including day-by-day itinerary information, stay-place information, transportation information, and cost information, and perform data formatting processing for converting the hierarchical structure data into display information visually recognizable by the user,
transmit the display information to the communication terminal and cause the operation screen on the communication terminal to visually display the itinerary information as one or more candidate proposals, and
receive, from the communication terminal, evaluation information or revised conditions relating to the itinerary information, update the internal condition information and the prompt sentence based on the evaluation information or the revised conditions, and iteratively request regeneration of the itinerary information from the generative information processing apparatus by using an updated prompt sentence.

### (Supplementary 2)

The system according to supplementary 1,
wherein the processor is configured to
cooperate with the generative information processing apparatus configured as a trained information processing model that has learned stored travel-related information, movement-route information, and usage-trend information, and, by causing the generative information processing apparatus to compare the cost condition, the time condition, and the preference condition included in the prompt sentence with the stored information, generate a plurality of pieces of itinerary information, and select, from the plurality of pieces of itinerary information, itinerary information that matches the user conditions to be presented as the display information.

### (Supplementary 3)

The system according to supplementary 1,
wherein the processor is configured to
execute information-linkage processing for associating the itinerary information with tourism-resource information, event information, and commercial-facility information each associated with a region, and include a result of the information-linkage processing in the display information to be presented to the user, thereby providing comprehensive experience information that contributes to activation of movement activities and activation of regional economic activities while substituting for brokerage operations.

### Application Example 1

### (Supplementary 1)

A system comprising a processor, a storage device, and a user terminal, wherein the processor is configured to
generate, on the user terminal as a user interface device, a user operation screen for receiving user requirement conditions including a cost condition, a time condition, and a preference condition, and to cause the user operation screen to be presented to a user,
receive, from the user terminal, user input data including the cost condition, the time condition, and the preference condition, validate and normalize the user input data, and execute a search process on a facility information storage area in the storage device in order to acquire candidate facility information based on the cost condition, the time condition, and the preference condition,
narrow down the acquired candidate facility information to a predetermined number of candidates, combine the narrowed candidate facility information with the user input data, and construct a prompt sentence as a text sequence including the cost condition, the time condition, the preference condition, and the candidate facility information for input to a generative AI model,
add constraint information to the prompt sentence to specify an output format and output items of a recommendation result by the generative AI model, and instruct the generative AI model to output a structured recommendation result,
transmit, as input to the generative AI model, the prompt sentence to the generative AI model, cause the generative AI model to select, from among the candidate facility information,
facilities that match the cost condition, the time condition, and the preference condition, and cause the generative AI model to generate the recommendation result including a recommendation reason and recommended usage content for each selected facility,
receive the recommendation result from the generative AI model, execute an additional query to the facility information storage area in the storage device to acquire detailed facility information corresponding to facility identification information included in the recommendation result, and integrate the recommendation result with the detailed facility information to generate presentation information for the user,
transmit the presentation information to the user terminal and cause the presentation information to be visually displayed in a list format or a detail screen format on the user operation screen of the user terminal,
receive, from the user terminal, selection information including facility identification information of a facility selected by the user and additional conditions including at least one of a number of users and a use time, execute a reservation process or an order process based on the selection information, and transmit a processing result of the reservation process or the order process to the user terminal, and
store, in the storage device as history information, the user input data, the recommendation result, and a history of the reservation process or the order process, generate preference feature information summarizing the history information, and, in subsequent recommendation processing, add the preference feature information to the prompt sentence to be input to the generative AI model so that a personalized recommendation result is generated for each user.

### (Supplementary 2)

The system according to supplementary 1,
wherein the processor is configured to cause the generative AI model to rank the candidate facility information based on a semantic relationship between text describing the candidate facility information included in the prompt sentence and the cost condition, the time condition, and the preference condition, to cause the generative AI model to output only facilities up to a predetermined number as the recommendation result, and to control the system such that candidate facility information not included in the recommendation result is discarded or treated as low priority.

### (Supplementary 3)

The system according to supplementary 1,
wherein the processor is configured such that the prompt sentence input to the generative AI model includes a natural-language expression indicating the cost condition, the time condition, and the preference condition, structured information summarizing the candidate facility information, and format specification information defining the output format of the recommendation result, and such that output from the generative AI model includes machine-readable structured data having elements including a facility identifier, a facility name, a recommendation reason, recommended usage content, and an estimated cost.

### Example 2

### (Supplementary 1)

A system comprising a processor,
wherein the processor is configured to
provide an information input/output interface by which a user inputs movement conditions including schedule information, location information, time information, and cost conditions, store the movement conditions, which are acquired via the information input/output interface, as structured data in an information storage area of a storage device,
transmit inquiry data, based on the movement conditions stored in the information storage area, to route information providing services and fare information providing services supplied by external information providing devices by using a communication protocol, and obtain movement candidate information including required time information, fare information, and time information for each movement means,
perform normalization processing, comparison processing, and evaluation processing on the obtained movement candidate information based on the time information, the fare information, and constraint conditions included in the movement conditions, and select an optimal movement means by using a scoring algorithm,
transmit reservation request data corresponding to the selected movement means to an external reservation service, receive, as a response, reservation identification information and reservation detail information, and store the reservation identification information and the reservation detail information in the information storage area so as to automatically execute reservation processing for the movement means,
generate a notification message based on the reservation detail information and provide the reservation detail information to a user terminal via an electronic mail transmission service or a notification distribution service,
and generate a prompt sentence that instructs processing contents to a generative artificial intelligence model based on the movement conditions and the movement candidate information, input the prompt sentence into the generative artificial intelligence model to obtain proposal information related to a movement plan, and convert the proposal information into output data for presentation to the user.

### (Supplementary 2)

The system according to supplementary 1,
wherein the processor is configured to
use past movement performance data and past reservation performance data stored in the information storage area as learning data, perform similarity evaluation and trend analysis with respect to the movement conditions of the user, update weighting parameters of the scoring algorithm based on results of the similarity evaluation and the trend analysis, and thereby continuously improve accuracy in selecting the optimal movement means.

### (Supplementary 3)

The system according to supplementary 1,
wherein the processor is configured to
associate and integrate the proposal information obtained from the generative artificial intelligence model with sightseeing information, event information, and facility information provided by a regional information providing service, and present the integrated information to the user, together with reservation information of the optimal movement means, as comprehensive movement plan information so as to contribute to automation of movement-related services and activation of regional activities.

### Application Example 2

### (Supplementary 1)

A system comprising a processor,
wherein the processor is configured to
receive, from a user terminal, input information including funding conditions, schedule conditions, and preference conditions of a user, via an information input/output interface, analyze natural language expressions included in the input information by language processing to convert the input information into structured information including date information, time information, location information, and price information, and generate, on the basis of the structured information and emotion information, a prompt sentence that instructs a generative information processing model to execute generation processing of a travel plan or a lifestyle plan,
input the prompt sentence into the generative information processing model, acquire candidate information including accommodation means, transportation means, and meal means generated by the generative information processing model in consideration of the structured information and the emotion information, collate the candidate information with route information, fee information, and availability information acquired from an external information processing service, and select concrete accommodation means, transportation means, and meal means,
execute, for the selected accommodation means, transportation means, and meal means, reservation processing or order processing via an information processing interface of an external reservation information processing apparatus, automatically acquire confirmation information as a result of the processing, and store and collectively manage the confirmation information by reservation management processing,
format, by display control processing, the confirmation information managed by the reservation management processing and the travel plan or the lifestyle plan generated by the selection of the accommodation means, the transportation means, and the meal means, into visual display information arranged in time order or category order, present the visual display information to a user display surface of the user terminal, and, in accordance with a change instruction or an approval instruction from the user, cause the generation of the prompt sentence and the selection of the accommodation means, the transportation means, and the meal means to be re-executed, and
analyze text information, voice information, or image information acquired from the user to estimate an emotion state of the user, and dynamically change, on the basis of the emotion state, contents of the prompt sentence and selection conditions of the concrete accommodation means, the transportation means, and the meal means by emotion adaptation processing.

### (Supplementary 2)

The system according to supplementary 1,
wherein the processor is configured to
use past plan information and past reservation information stored in a storage device as learning data, extract preference information for each user by the generative information processing model or by a separate inference processing unit, and select, by comparing the structured information and the emotion information with the preference information, an optimized travel plan or lifestyle plan for the user from the candidate information.

### (Supplementary 3)

The system according to supplementary 1,
wherein the processor is configured to
include, in the prompt sentence to the generative information processing model, an instruction to take into account region-related tourism information, event information, facility information, or meal information, generate comprehensive plan information in which the accommodation means, the transportation means, and the meal means are combined with the region-related information, and cause the display control processing to present the comprehensive plan information to the user terminal so as to provide experience information that contributes to activation of regional activities and activation of economic activities.

What is claimed is:

1. A system comprising:
circuitry configured to:
receive, via a communication interface coupled to a packet-switched network, a set of constraint parameters and a set of preference parameters from a terminal device;
analyze the set of constraint parameters and the set of preference parameters and construct a natural-language prompt sentence encoding the analyzed constraint parameters and preference parameters;
supply the natural-language prompt sentence to a transformer-based generative neural network model and acquire inference output data comprising a structured proposal matching the constraint parameters and the preference parameters; and
generate visually formatted output data based on the structured proposal and transmit the visually formatted output data, via the communication interface coupled to the packet-switched network, to the terminal device for rendering on a display of the terminal device.

2. The system according to claim 1, wherein the circuitry is further configured to:
store the set of constraint parameters and the set of preference parameters as structured data records in a non-transitory storage medium, the structured data records comprising fields for a date value, an origin location, a destination location, a departure time, a maximum cost value, and a user identifier.

3. The system according to claim 2, wherein the circuitry is further configured to:
transmit, via the communication interface, query requests derived from the set of constraint parameters to one or more external information providing services; and
receive candidate information from the one or more external information providing services, the candidate information comprising route data, fare data, departure time data, and arrival time data for each candidate option.

4. The system according to claim 3, wherein the circuitry is further configured to:
normalize the candidate information by converting time values and cost values into internal units and scaling them to a unified numerical range; and
represent each candidate option as a feature vector comprising normalized duration, normalized cost, departure time deviation, and additional attributes.

5. The system according to claim 4, wherein the circuitry is further configured to:
compute a score for each candidate option by applying a scoring algorithm to the feature vector using weighting coefficients derived from the set of preference parameters; and
rank the candidate options in descending order of the computed scores and select a subset of top-ranked candidate options.

6. The system according to claim 5, wherein constructing the natural-language prompt sentence comprises:
selecting a prompt template from a template repository stored in the non-transitory storage medium;
inserting the set of constraint parameters, the set of preference parameters, and data from the subset of top-ranked candidate options into placeholders of the prompt template; and
converting the completed prompt template into a token sequence using a tokenizer compatible with the transformer-based generative neural network model.

7. The system according to claim 6, wherein the transformer-based generative neural network model processes the token sequence through a plurality of self-attention layers and feed-forward layers and generates the inference output data as a token sequence representing the structured proposal in a constrained output format.

8. The system according to claim 7, wherein the circuitry is further configured to:
parse the inference output data to extract a plurality of proposal entries, each proposal entry comprising an itinerary segment with a transportation mode, a departure time, an arrival time, a cost, and a description.

9. The system according to claim 1, wherein the circuitry is further configured to:
apply an emotion estimation neural network classifier to at least one of text data and interaction pattern data received from the terminal device to compute a dominant emotion category; and
adjust content of the natural-language prompt sentence based on the dominant emotion category to influence a style or emphasis of the structured proposal generated by the transformer-based generative neural network model.

10. The system according to claim 9, wherein the emotion estimation neural network classifier receives word embeddings or behavioral feature vectors and outputs a probability distribution over emotion categories via a softmax output layer.

11. The system according to claim 1, wherein the circuitry is further configured to:
receive, from the terminal device via the communication interface, selection information indicating a selected proposal entry from the structured proposal; and
transmit, via the communication interface, a reservation request derived from the selected proposal entry to an external reservation service to initiate a booking process.

12. The system according to claim 11, wherein the circuitry is further configured to:
receive reservation confirmation data from the external reservation service and store the reservation confirmation data in the non-transitory storage medium in association with the user identifier.

13. The system according to claim 12, wherein the circuitry is further configured to:
retrieve, from the one or more external information providing services, regional event information and local attraction information associated with a destination indicated in the selected proposal entry; and
generate a supplemental information package comprising the regional event information and the local attraction information and transmit the supplemental information package to the terminal device.

14. The system according to claim 1, wherein the circuitry is further configured to:
store past proposal data and associated user selection history in the non-transitory storage medium; and
compare the set of constraint parameters and the set of preference parameters with the past proposal data to compute similarity scores and adjust the natural-language prompt sentence to incorporate learnings from past selections.

15. The system according to claim 14, wherein comparing comprises:
encoding the set of preference parameters and the past proposal data as embedding vectors using a neural encoder; and
computing cosine similarity between the embedding vectors to identify historically preferred proposal patterns.

16. The system according to claim 15, wherein the set of constraint parameters comprises a budget value, schedule dates, and time constraints, and the set of preference parameters comprises qualitative experience preferences, and wherein the structured proposal comprises a travel itinerary including transportation options, accommodation options, and activity recommendations tailored to the budget value and the qualitative experience preferences.

17. The system according to claim 16, wherein generating the visually formatted output data comprises:
converting the structured proposal into a document format with section headings for each itinerary day, list entries for transportation and accommodation, cost summaries, and map-based location indicators.

18. A system comprising:
circuitry configured to:
receive, via a communication interface coupled to a packet-switched network conforming to at least one of a 5G, Wi-Fi, or Bluetooth communication standard, a set of constraint parameters comprising a budget value, schedule dates, and time constraints, and a set of preference parameters comprising qualitative experience preferences, from a terminal device comprising a display and an input device;
transmit query requests derived from the set of constraint parameters to external information providing services via the communication interface and receive candidate information comprising route data, fare data, and timing data;
normalize the candidate information, represent each candidate option as a feature vector, compute scores using weighting coefficients derived from the set of preference parameters, and select a subset of top-ranked candidate options;
construct a natural-language prompt sentence by inserting the constraint parameters, the preference parameters, and the subset of top-ranked candidate options into a prompt template;
apply an emotion estimation neural network classifier to data received from the terminal device to compute a dominant emotion category and adjust the natural-language prompt sentence based on the dominant emotion category;
supply the natural-language prompt sentence to a transformer-based generative neural network model comprising a stack of self-attention layers and feed-forward layers and acquire inference output data comprising a structured proposal;
parse the inference output data to extract proposal entries each comprising itinerary segments with transportation modes, times, costs, and descriptions;
generate visually formatted output data from the structured proposal with section headings, list entries, cost summaries, and location indicators; and
transmit the visually formatted output data to the terminal device via the communication interface coupled to the packet-switched network for rendering on the display.

19. The system according to claim 18, wherein the circuitry is further configured to:
receive selection information from the terminal device indicating a selected proposal entry and transmit a reservation request to an external reservation service via the communication interface to initiate a booking process, and receive and store reservation confirmation data.

20. A method comprising:
receiving, by circuitry via a communication interface coupled to a packet-switched network, a set of constraint parameters and a set of preference parameters from a terminal device;
analyzing, by the circuitry, the set of constraint parameters and the set of preference parameters and constructing a natural-language prompt sentence encoding the analyzed constraint parameters and preference parameters;
supplying, by the circuitry, the natural-language prompt sentence to a transformer-based generative neural network model and acquiring inference output data comprising a structured proposal matching the constraint parameters and the preference parameters; and
generating, by the circuitry, visually formatted output data based on the structured proposal and transmitting the visually formatted output data, via the communication interface coupled to the packet-switched network, to the terminal device for rendering on a display of the terminal device.
